(19) United States
(12) Patent Application Publication
(10) Pub. No.: US 2023/0407690 A1
(43) Pub. Date: Dec. 21, 2023

(54) Deployable Structure And Hinge Structure

(71) Applicant: Technosolver Corporation, Fujisawa-Shi (JP)

(72) Inventors: Kazuyuki NAKAMURA, Fujisawa-shi (JP); Nobuko NAKAMURA, Fujisawa-shi (JP)

(21) Appl. No.: 18/334,870

(22) Filed: Jun. 14, 2023

(30) Foreign Application Priority Data
Jun. 21, 2022 (JP) 2022-099403
Apr. 19, 2023 (JP) 2023-068407

(51) Int. Cl. E05D 3/12; E05D 5/02

(52) U.S. Cl. CPC E05D 3/12; E05D 5/02

(57) ABSTRACT

A first member and a second member of a hinge unit are rotatably connected to each other via a rotation shaft. The first member includes a support portion. The first member is connected to an end edge portion of a first structure slidably in a predetermined sliding direction, and the second member is connected to an end edge portion of a second structure. An urging member is disposed between the support portion and the first structure. When transitioning from a folded state to a deployed state, the urging member urges and moves the first structure in the sliding direction toward the second structure, and at least a part of the hinge unit sinks into an inside from an outside of the first structure.

### CROSS-REFERENCE TO RELATED APPLICATIONS

This application claims the benefits of Japanese Patent Applications No. 2022-099403 filed on Jun. 21, 2022 and No. 2023-068407 filed on Apr. 19, 2023 in the Japanese Patent Office, the disclosures of which are herein incorporated in their entirety by reference.

### FIELD OF THE INVENTION

The present invention relates to a deployable structure that transitions from a folded state to a deployed state by deployment operation, and a hinge structure included in such a deployable structure.

### BACKGROUND OF THE INVENTION

For articles having substantially planar portions, it is generally desirable that the substantially planar portions are continuous and free of irregularities. On the other hand, the accommodation space for articles may be limited. The articles including the substantially planar portions are provided as the deployable structures that can be folded to reduce the area viewed from a predetermined direction when the articles are carried by persons or transported by transport planes and can be deployed into a large area for use and then used. Examples of articles that have substantially planar portions and are provided as deployable structures include electronic devices such as game machines or mobile phones, and solar cell paddles, deployable antennas or the like mounted on spacecraft.

Japanese Laid-open patent publication No. H10-147298 discloses a solar cell paddle as an example of the deployable structure. In the solar cell paddle, a plurality of plate-shaped solar panels (1) are coupled to each other with deployment hinges (4). When the solar cell paddle is accommodated, the solar cell paddle is folded so that surfaces of two solar panels are parallel to each other. Specifically, the solar cell paddle is folded into an accordion shape (W shape) by alternately folding a plurality of hinges (4) into mountain shapes and valley shapes as illustrated in FIGS. 1 to 3 in Japanese Laid-open patent publication No. H10-147298. Alternatively, the solar cell paddle (1) is spirally folded such that solar panels (1a, 1b) adjacent to both ends are folded in a same direction as illustrated in FIGS. 4 to 6 in Japanese Laid-open patent publication No. H10-147298, and a plurality of (three in FIGS. 4 to 6) solar panels (1) can be made into a thick envelope volume of one sheet. From the folded state, the plurality of deployment hinges (4) that are fixed to side end surfaces of the respective solar panels (1) rotate in order, and thereby the solar panels (1) transition to a deployed state in which they line up on a plane.

Japanese Laid-open patent publication No. 2011-119830 discloses a foldable mobile terminal as an example of a deployable structure. In the foldable mobile terminal, two casings (3, 5) accommodating display modules (11, 12) are coupled to each other with a hinge unit (6) attached to a casing side surface, and the foldable mobile terminal can be folded so that the two casings face each other. As illustrated in FIG. 13 of Japanese Laid-open patent publication No. 2011-119830, leaf springs (27) are disposed between the display modules (11, 12) and the casings (3, 5). In the deployed state, the two display modules are urged inward from outside by the leaf springs, the two display modules abut on each other.

Japanese Laid-open patent publication No. H07-187089 will be described later.

In the related art, it is general to make the substantially planar portions foldable by coupling panels each constituting a division of a plane, with hinges. In the deployable structure in Japanese Laid-open patent publication No. H10-147298, a gap occurs between the solar panels (1) since the deployment hinge (4) such as a rotation shaft is disposed between the solar cell panels (1) in the deployed state, and continuity of the substantially planar portions is lost.

Examples of the panel that is folded after being divided include screens of electronic devices such as mobile phones, or game machines, antennas of synthetic aperture radars, solar panels of solar cell paddles or the like. If a gap occurs between panels, the image displayed in the screen of an electronic device is divided, the antenna of a synthetic aperture radar has a part that cannot receive microwaves, and a solar paddle has a part that cannot generate power. Accordingly, the substantially planar portion is preferably provided in a state in which there are as few gaps as possible in the deployed state.

In the mobile terminal of Japanese Laid-open patent publication No. 2011-119830, the display modules (11, 12) that are panels can be caused to abut on each other without gaps by an urging force of the leaf springs in the deployed state. However, since it is necessary to dispose the casings (3, 5) for supporting the leaf springs in the perimeters of the display modules (11, 12), design in the perimeters of the display modules is limited. For example, when another display module is additionally coupled to the two display modules to form a structure including the three panels, the presence of the casings limits the sides to which the new display module can be coupled in the two display modules. Further, in the mobile terminal of Japanese Laid-open patent publication No. 2011-119830, the casings cannot be removed for the purpose of miniaturization or design. It is general that a synthetic aperture radar and a solar cell paddle are designed so that three or more panels are linearly coupled, and it is preferable that all the three or more panels are coupled to one another without gaps. However, in the method of coupling the panels (display modules (11, 12)) as in Japanese Laid-open patent publication No. 2011-119830, it is possible to couple the two panels without gaps by the urging force of the leaf springs, but it is difficult to couple the third panel linearly without gaps. This is because when further coupling the third panel to the two panels aligned side by side, the second panel is coupled to a side end surface on one side of the first panel, and the casing is provided on the side end surface on the other side, so that it is impossible to couple the third panel without gaps here. Electronic devices are sometimes required to have smaller bezels from a design standpoint, and articles such as synthetic aperture radars, solar cell paddles, and electronic devices are often required to be miniaturized. Accordingly, there is a strong desire for a deployable structure or a hinge structure that is not subject to restrictions on design that prevent miniaturization, such as the casings that surround the display modules.

### SUMMARY

The preset invention is made in view of the problems as described above and provides a hinge structure with few design restrictions on a perimeter of a panel in reducing a gap between panels, and a deployable structure that deploys a plane in such a way.

According to the present invention, there is provided a deployable structure including a first structure, a second structure, and a hinge unit that connects the first structure and the second structure rotatably to cause the first structure and the second structure to transition from a folded state to a deployed state, the first structure and the second structure being disposed side by side with each other with end edge portions facing each other in the deployed state, wherein the hinge unit includes a first member and a second member rotatably connected to each other via a rotation shaft, and an urging member, the first member includes a support portion and is connected to the end edge portion of the first structure slidably in a predetermined sliding direction, and the second member is connected to the end edge portion of the second structure, and the urging member is disposed between the support portion and the first structure, the urging member urges and moves the first structure in the sliding direction toward the second structure when transitioning from the folded state to the deployed state, and at least a part of the hinge unit sinks into an inside from an outside of the first structure.

In addition, according to the present invention, there is provided a hinge structure including a first bracket, a second bracket, and a hinge unit that connects the first bracket and the second bracket rotatably to cause the first bracket and the second bracket to transition from a folded state to a deployed state, the hinge unit includes a first member and a second member that are rotatably connected to each other via a rotation shaft, and an urging member, the first member includes a support portion, and is connected to the first bracket slidably in a predetermined sliding direction, and the second member is connected to the second bracket, and the urging member is disposed between the support portion and the first bracket, the urging member urges and moves the first bracket in the sliding direction toward the second bracket when transitioning from the folded state to the deployed state, and at least a part of the hinge unit sinks into an inside from an outside of the first bracket.

When the deployable structure of the above-described invention transitions from the folded state to the deployed state, the first structure slides in a direction to be closer to the second structure, and at least a part of the hinge unit disposed between the first structure and the second structure sinks into the inside of the first structure. This reduces the gap that occurs between the first structure and the second structure. Further, the first structure and the second structure are connected via the hinge unit in the end edge portions that are close to each other in the deployed state. Thereby, the hinge unit does not protrude on the outer peripheries of the first structure and the second structure, and restrictions on design around the deployable structure can be reduced.

According to the deployable structure and the hinge structure of the preset invention, restrictions on design to the outer periphery of the structure (the first structure or the second structure) can be minimized while the gap between the panels is reduced. For example, one more panel can be linearly connected to the structure, and in addition, an article using the deployable structure can be miniaturized.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1A is a perspective view of a deployable structure in a folded state according to a first embodiment;

FIG. 1B is a sectional view cut on a width center of a hinge structure in FIG. 1A;

FIG. 2A is a perspective view of a deployable structure during deployment operation according to the first embodiment;

FIG. 2B is a sectional view cut on the width center of the hinge structure in FIG. 2A;

FIG. 3A is a perspective view of the deployable structure in a deployed state according to the first embodiment;

FIG. 3B is a sectional view cut on the width center of the hinge structure in FIG. 3A;

FIG. 4A is a perspective view of a deployable structure in a folded state according to a second embodiment;

FIG. 4B is a sectional view cut on a width center of a hinge structure in FIG. 4A;

FIG. 5A is a perspective view of the deployable structure during deployment operation according to the second embodiment;

FIG. 5B is a sectional view cut on the width center of the hinge structure in FIG. 5A;

FIG. 6A is a perspective view of the deployable structure in a deployed state according to the second embodiment;

FIG. 6B is a sectional view cut on the width center of the hinge structure in FIG. 6A;

FIG. 7A is a perspective view of a deployable structure in a folded state according to a third embodiment;

FIG. 7B is an enlarged view of a region X of FIG. 7A;

FIG. 8A is a perspective view of the deployable structure during deployment operation according to the third embodiment;

FIG. 8B is an enlarged view of the region X of FIG. 8A;

FIG. 9 is a perspective view of the deployable structure in a deployed state according to the third embodiment;

FIG. 10A is a schematic view of a deployable structure in a folded state according to a modification; and

FIG. 10B is a schematic view of the deployable structure in a deployed state according to the modification.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purpose.

Hereinafter, embodiments of the present invention will be described based on the drawings. Note that same components in all the drawings will be assigned with the same reference signs, and redundant explanation will not be repeated.

In the following explanation, a deployable structure 100 is described as a solar cell paddle, but the present invention is not limited to this. As described above, the present invention can also be applied to electronic devices such as foldable mobile phones or game machines, and other articles.

### First Embodiment

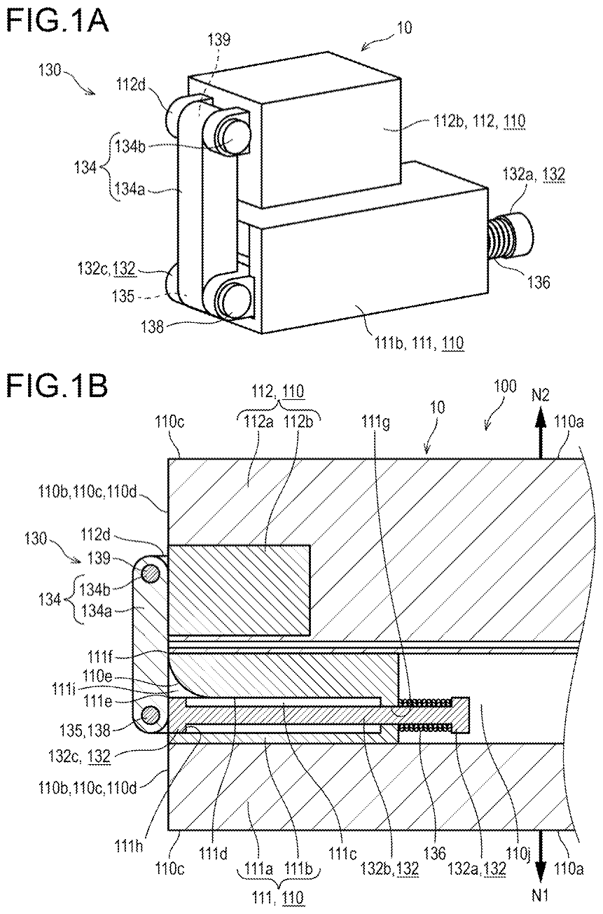

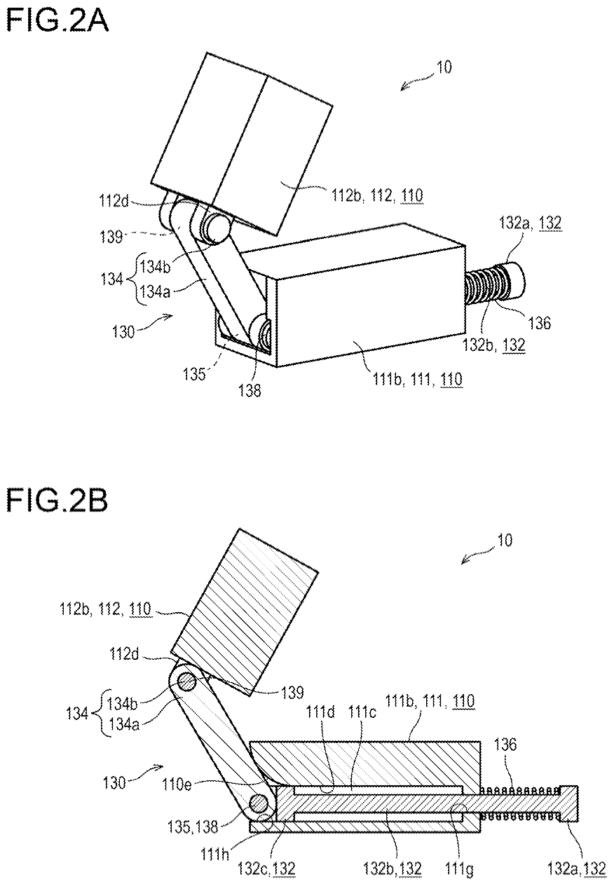

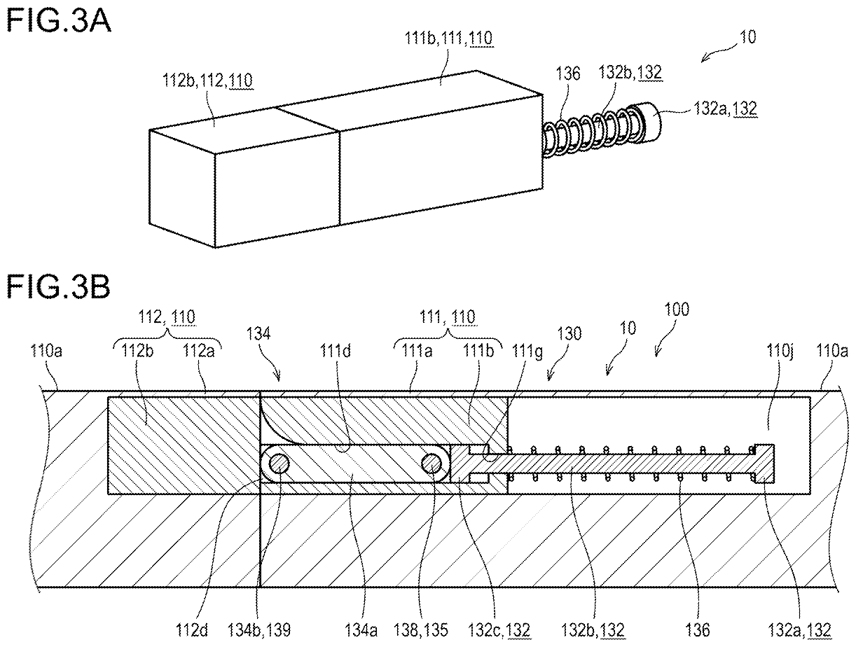

FIGS. 1A, 1B, 2A, 2B, 3A and 3B are schematic views explaining a principle of a deployment sequence of the deployable structure 100 of a first embodiment of the present invention. Specifically, FIGS. 1A and 1B are explanatory views of a folded state of the deployable structure 100 of the present embodiment. FIGS. 2A and 2B are explanatory views of the deployable structure 100 during deployment operation. FIGS. 3A and 3B are explanatory views of a deployed state of the deployable structure 100. In FIGS. 1A, 2A, 2B and 3A, a first panel 111a and a second panel 112a are not illustrated.

In the present embodiment, in a first structure 111, a first member 132, and a first urging member 136, a link member 134a side is described as “front end side”, and an opposite side thereof, specifically, a first support portion 132a side is described as “rear end side”. For example, in FIG. 1B, a front end side of a structure 110, the first member 132, and the first urging member 136 is a left side on the drawing, and a rear end side is a right side on the drawing. In FIG. 3B, a front end side of the first structure 111, the first member 132, and the first urging member 136 is a left side on the drawing, and a rear end side is a right side on the drawing, but a front end side of a second structure 112 is a right side on the drawing, whereas a rear end side is a left side on the drawing. Further, in the first structure 111 and the second structure 112, when the first structure 111 and the second structure 112 face each other in a folded state, a side facing each other is referred to as “inner side”, and an opposite side thereof is referred to as “outer side”. For example, in FIG. 1B, the inner side for the first structure 111 is an upper side on the drawing, and the outer side is a lower side on the drawing. Further, the inner side for the second structure 112 is the lower side on the drawing, and the outer side is the upper side on the drawing.

In the present embodiment, a width direction is a direction in which a main surface of the panel extends when the deployable structure 100 is viewed in a direction of a front-rear end direction, which is a depth direction of a paper surface in FIG. 1B. Further, a direction orthogonal to the width direction when the deployable structure 100 is viewed in a front-rear end direction is called a thickness direction. That is to say, in the folded state illustrated in FIG. 1B, the first structure 111 and the second structure 112 are adjacent to each other in the thickness direction. The same applies to a width direction and a thickness direction in a hinge structure 10. A direction in which a first bracket 111b and a second bracket 112b face each other in the folded state is called the thickness direction, and a direction orthogonal to both the front-rear end direction and the thickness direction is called the width direction.

First, an outline of the present embodiment will be described.

The deployable structure 100 of the present embodiment has the first structure 111, the second structure 112, and a hinge unit 130. The hinge unit 130 connects the first structure 111 and the second structure 112 rotatably and causes them to transition from the folded state to a deployed state. In the deployed state, the first structure 111 and the second structure 112 are disposed side by side with each other with end edge portions 110c facing each other. The hinge unit 130 has the first member 132, a second member 134, and the first urging member 136. The first member 132 and the second member 134 are rotatably connected to each other via a rotation shaft 138. The first member 132 has the first support portion 132a. The first member 132 is connected to the end edge portion 110c of the first structure 111 slidably in a predetermined sliding direction, and the second member 134 is connected to the end edge portion 110c of the second structure 112. Specifically, the first member 132 slides in an extending direction of the first member 132. The first urging member 136 is disposed between the first support portion 132a and the first structure 111. When the folded state transitions to the deployed state, the first urging member 136 urges and moves the first structure 111 in the sliding direction toward the second structure 112, and at least a part of the hinge unit 130 sinks into an inside from an outside of the first structure 111.

The hinge structure 10 is used with a first panel 111a and a second panel 112a to configure the deployable structure 100. The hinge structure 10 of the present embodiment has the first bracket 111b, the second bracket 112b, and the hinge unit 130. The hinge unit 130 connects the first bracket 111b and the second bracket 112b rotatably to cause them to transition from the folded state to the deployed state. The hinge unit 130 has the first member 132, the second member 134, and the first urging member 136. The first member 132 and the second member 134 are rotatably connected to each other via the rotation shaft 138. The first member 132 has the first support portion 132a. The first member 132 is connected to the first bracket 111b slidably in the predetermined sliding direction. Specifically, the first member 132 slides in the extending direction of the first member 132. The second member 134 is connected to the second bracket 112b. The first urging member 136 is disposed between the first support portion 132a and the first bracket 111b. When the folded state transitions to the deployed state, the first urging member 136 urges and moves the first bracket 111b in the sliding direction toward the second bracket 112b, and at least a part of the hinge unit 130 sinks into an inside from an outside of the first bracket 111b.

Next, the deployable structure 100 and the hinge structure 10 of the present embodiment will be described in detail.

The deployable structure 100 assumes a state in which an area of the deployable structure 100 viewed from a predetermined direction is small when it is carried by a person or transported by a transport plane. Further, when used, at least a part of the deployable structure 100 performs deployment operation and thereby the deployable structure 100 deploys so that the area of the deployable structure 100 viewed from a predetermined direction becomes larger than that of the carried state or the transported state. The deployable structure 100 of the present embodiment includes two structures 110 (the first structure 111, the second structure 112), and the hinge unit 130 that couples the structures 110 to each other. A state in which the area viewed from a predetermined direction before the deployment operation is referred to as the folded state, and a state in which the area viewed from the above-described predetermined direction after the deployment operation is larger than that of the folded state is referred to as the deployed state. However, as described later, the deployable structure 100 may be the one in which three or more structures 110 are coupled by two or more hinge units 130.

Note that a state of each member and a relative positional relationship between members when the deployable structure 100 is in the folded state are referred to as the folded state of the member or the folded state of the members. Likewise, a state of each member and a relative positional relationship between members when the deployable structure 100 is in the deployed state are referred to as the deployed state of the member or the deployed state of the members. For example, the first member 132 and the second member 134 being in the folded state means that an angle formed by the first member 132 and the link member 134a (the second member 134) around the rotation shaft 138 is approximately 90 degrees as in FIG. 1B. Further, the first member 132 and the second member 134 being in the deployed state means that the angle formed by the first member 132 and the link member 134a (the second member 134) around the rotation shaft 138 is approximately 180 degrees as in FIG. 3B.

The structure 110 is an object that rotates by the hinge unit 130. The deployable structure 100 includes the first structure 111 and the second structure 112 as the structure 110. The first structure 111 includes the first panel 111a and the first bracket 111b, and the second structure 112 includes the second panel 112a and the second bracket 112b. That is to say, the structure 110 is configured by part of the hinge structure 10 (the first bracket 111b and the second bracket 112b), and members (the first panel 111a and the second panel 112a) other than the hinge structure 10.

The first bracket 111b and the second bracket 112b are components or parts to which the first member 132 or the second member 134 in the structure 110 (the first structure 111 and the second structure 112) are connected. The first panel 111a and the second panel 112a are plate-shaped members each having a plane. When the deployable structure 100 is a solar cell paddle, the first panel 111a and the second panel 112a are solar panels in which solar cells are stacked on substrates each configured by a honeycomb panel or the like. When the deployable structure 100 is a reflector for transmission or reception such as an antenna reflector or an optical reflector, or a shield such as an optical shield or a heat shield, the first panel 111a and the second panel 112a are reflection boards.

The first bracket 111b and the second bracket 112b are fixed by being embedded into, coupled to a side end surface 110b of the first panel 111a or the second panel 112a or the like. The first bracket 111b and the first panel 111a, and the second bracket 112b and the second panel 112a may be separate members respectively. Alternatively, the first bracket 111b and the first panel 111a may be made one integrated member to configure the first structure 111, and the second bracket 112b and the second panel 112a may be made one integrated member to configure the second structure 112.

The hinge structure 10 includes the hinge unit 130, the first bracket 111b and the second bracket 112b, and couples the first panel 111a and the second panel 112a rotatably. The deployable structure 100 in the present embodiment is made by coupling the first panel 111a and the second panel 112a with the hinge structure 10.

The first bracket 111b and the second bracket 112b rotate by the hinge unit 130, and the first structure 111 and the second structure 112 change their relative positions, whereby the deployable structure 100 transitions from the folded state to the deployed state.

The hinge unit 130 is a component that connects the first structure 111 and the second structure 112 rotatably. In other words, the first structure 111 and the second structure 112 are in a connected state without separating, by the hinge unit 130. In the present embodiment, the hinge unit 130 is specifically a hinge with the rotation shaft 138. The hinge unit 130 includes the first member 132, the second member 134, and the first urging member 136. The first member 132 and the second member 134 are members to be rotatable relative to each other around the rotation shaft 138, and are each configured by one member or a combination of a plurality of members. The first member 132 is connected to the first structure 111, and the second member 134 is connected to the second structure 112. The first member 132 is inserted through the end edge portion 110c of the first structure 111, and the first member 132 slides in the extending direction of the first member 132 in the inside of the first structure 111. Here, the end edge portion 110c refers to a main surface 110a in a vicinity of a side end surface 110b of the structure 110 or the side end surface 110b.

Here, the main surface 110a is a surface of the structure 110 configuring a substantially plane in the deployable structure 100 in the deployed state, and the side end surface 110b is an end surface that connects peripheral edges of the main surfaces 110a on a front and a back of the structure 110. The side end surface 110b need not be a physical surface. For example, when the first panel 111a that configures the structure 110 is a hollow body such as a honeycomb panel, the side end surface 110b may be an imaginary surface that connects the peripheral edges of the main surfaces 110a on the front and back. Note that “surfaces” such as the main surface 110a and the side end surface 110b need not be geometrically complete surfaces but may include local irregularities or a partial loss. When the first bracket 111b is embedded in the first panel 111a, and a part of the first bracket 111b protrudes from an end surface of the first panel 111a, a part of the first bracket 111b protruded from the end surface of the first panel 111a configures the side end surface 110b of the first structure 111 with the end surface of the first panel 111a.

The first member 132 has the support portion (first support portion 132a). In a second embodiment described later, a deployable structure 100 has a first support portion 132a and a second support portion 134d as support portions, but in the present embodiment, the deployable structure 100 has only the first support portion 132a. The first support portion 132a is a part for abutting on the first urging member 136 and applying the urging force of the first urging member 136 to the entire first member 132. In the present embodiment, the first support portion 132a is a part that is made by forming an end portion of a shaft portion (first shaft portion 132b) of the first member 132 into a flange shape. The first member 132 is a long object having the first shaft portion 132b. The extending direction of the first member 132 means a long length direction of the first member 132.

The urging member is a member that urges the first structure 111 or the second structure 112 to the front end side in the deployed state. The deployable structure 100 in the second embodiment described later has a first urging member 136 and a second urging member 137 as urging members. The deployable structure 100 according to the present embodiment includes only the first urging member 136. In the present embodiment, the first urging member 136 is a coil spring. The first member 132 is inserted through an inside of the coil spring. The first urging member 136 may be configured by one coil spring or may be configured by arranging a plurality of coil springs in series or parallel. The first urging member 136 in the folded state is disposed between the first structure 111 and the first support portion 132a in a state in which the first urging member 136 is compressed in advance. Accordingly, the first urging member 136 applies an outward urging force in the extending direction of the first member 132 to the first structure 111 and the first support portion 132a.

The first member 132 has a first bearing portion 132c at the other end on an opposite side from the first support portion 132a. The first bearing portion 132c is combined with the second member 134 by the rotation shaft 138.

Note that the present invention is not limited to an aspect of the present embodiment, and includes aspects of various modifications, alterations and the like. For example, the first support portion 132a may be formed at the end portion of the first member 132 as shown in the present embodiment, or may be formed in a middle portion in the length direction of the first member 132. Further, in the present embodiment, an aspect in which the coil spring is used as the first urging member 136 is illustrated, but other elastic members such as a disc spring may be used as the first urging member 136, or a member by a mechanism that applies a driving force regardless of an elastic force may be used. For example, a mechanism or the like that is fixed to the first structure 111 and pulls the first member 132 is illustrated as the first urging member 136. In this case, the first support portion 132a is a part to which the mechanism is coupled, in the first member 132. As the mechanism, a wire pulling mechanism including a wire and a wire pulling unit is specifically cited. In an example of the wire puling mechanism, one end of the wire can be coupled to either one of the first support portion 132a or the first structure 111, and the pulling unit can be installed at the other end. By pulling the other end of the wire by the pulling unit, the first member 132 is moved to the rear end side relatively to the first structure 111. As specific pulling units, there are cited a pulling unit that pulls the other end of the wire by a contractile force of a spring stretched in advance, a pulling unit that winds up the other end of the wire by a rotational force of a motor, and the like.

In the present embodiment, the first structure 111 and the first support portion 132a have shapes and sizes that include a pressing surface of the first urging member 136 when viewed in an axial direction of the first member 132. In other words, when a coil spring is used as the first urging member 136, an entire surface of an end surface of one side (right side in FIG. 1B) of the coil spring is in contact with the flange-shaped first support portion 132a. The first support portion 132a is formed to be large enough for the entire surface of the end surface of the coil spring to contact the first support portion 132a. Further, an entire surface of an end surface on an opposite side (left side in the drawing) of the coil spring contacts a part that forms a periphery of the insertion hole 111g through which the first member 132 is inserted in the first structure 111. Further, the insertion hole 111g is formed to be small enough for the entire surface of the end surface of the coil spring to contact the part of the first structure in this way. Thereby, the urging force of the first urging member 136 can be applied efficiently to the first support portion 132a and the first structure 111.

In the present embodiment, the second member 134 has a link member 134a. The link member 134a consists of one or a plurality of members with the rotation shaft 138 and the second rotation shaft 134b as both ends. The link member 134a is rotatably coupled to the second structure bearing portion 112d that is a protruding portion of the second structure 112 by the second rotation shaft 134b. In the present embodiment, a combination of the link member 134a and the second rotation shaft 134b is referred to as the second member 134.

Instead of the present embodiment, the second member 134 may be a rigid body that does not have a rotatable structure. For example, when a state in which a deployment angle of the first structure 111 and the second structure 112 is approximately 90 degrees is a folded state as described later, the second member 134 may be configured like this. Specifically, the second member 134 may not have a second assistance urging member 139, and the link member 134a and the second bracket 112b may be integrally formed as a rigid body. In other words, in FIG. 1B, the second bracket 112b is disposed to be upright with respect to the first bracket 111b, and the second panel 112a may extend in an up-down direction in FIG. 1B.

As illustrated in FIGS. 1A and 1B, in the folded state, the main surface 110a of the first structure 111 is disposed to overlap the main surface 110a of the second structure 112 in the thickness direction, and to be substantially parallel thereto. Specifically, an angle formed by a normal vector N1 that points to the outer side with respect to the main surface 110a of the first structure 111 and a normal vector N2 pointing to the outer side with respect to the main surface 110a of the second structure 112 is approximately 180 degrees. Here, a supplementary angle of the angle formed by the normal vector N1 and the normal vector N2 is defined as a deployment angle. In FIGS. 1A and 1B, the deployment angle is 0 degrees. The deployment angle in the folded state is not limited to 0 degrees and can be equal to or less than 120 degrees, for example. Further, the deployment angle in the folded state is preferably equal to or less than 90 degrees. More preferably, the deployment angle in the folded state is equal to or less than 75 degrees. Instead of the present embodiment, the deployment angle in the folded state can be equal to or more than 90 degrees and less than 180 degrees. In other words, in the folded state, the second panel 112a may be in an upright state with respect to the first panel 111a or may be in a state more open than the upright state. The upright state of the second panel 112a with respect to the first panel 111a means a state in which the deployment angle in the folded state is approximately 90 degrees, for example. A case in which the deployment angle in the folded state is slightly smaller than 90 degrees or slightly larger than 90 degrees may be deemed as the upright state of the second panel 112a with respect to the first panel 111a. Deployment of the deployable structure 100 may be started from the state in which the second panel 112a is upright with respect to the first panel 111a or the state more open than the upright state.

In the deployed state, the deployment angle is larger than that in the folded state. In the deployed state illustrated in FIGS. 3A and 3B, a state in which the first structure 111 and the second structure 112 are disposed side by side with the side end surfaces 110b adjacent to each other and the deployment angle is 180 degrees is illustrated. However, the deployed state in the present invention is not limited to this, and the deployment angle is sufficient if the deployment angle is larger than that in the folded state. A typical deployment angle in the deployed state is equal to or more than 150 degrees and equal to or less than 210 degrees.

Next, deployment operation of transitioning from the folded state to the deployed state of the deployable structure 100 according to the present embodiment will be described. In the deployable structure 100 in the folded state illustrated in FIGS. 1A and 1B, the first urging member 136 urges the first support portion 132a and the first structure 111 outward in the extending direction of the first member 132. The deployable structure 100 deploys from the folded state by the second structure 112 relatively rotating with respect to the first structure 111 by the hinge unit 130. Specifically, the first member 132 and the link member 134a relatively rotate around the rotation shaft 138, and the link member 134a and the second structure 112 relatively rotate around the second rotation shaft 134b, whereby the deployable structure 100 deploys.

FIGS. 2A and 2B show one example during the deployment operation of the deployable structure 100 and show a state in which the deployable structure 100 is deployed until the deployment angle reaches approximately 60 degrees. In the present embodiment, a total of an angle by which the first member 132 and the link member 134a rotate around the rotation shaft 138, and an angle by which the link member 134a and the second structure 112 rotate around the second rotation shaft 134b is the deployment angle of the deployable structure 100. That is to say, in FIGS. 2A and 2B in which the deployment angle is 60 degrees, the first member 132 and the link member 134a, and the link member 134a and the second structure 112 are each rotated by 30 degrees from the folded state.

In the present embodiment, the first member 132 and the link member 134a, and the link member 134a and the second structure 112 evenly rotate so that the deployment angle becomes a predetermined angle, but the present invention is not limited to this. In the present invention, rotation of the first member 132 and the link member 134a, and rotation of the link member 134a and the second structure 112 may not be synchronized. For example, the first member 132 and the link member 134a may not rotate until the deployment angle becomes the predetermined deployment angle, and only the link member 134a and the second structure 112 may rotate, after which, rotation of the first member 132 and the link member 134a may start.

FIGS. 3A and 3B show an example of the deployed state in which the first structure 111 and the second structure 112 are disposed side by side, and the deployment angle is 180 degrees. When the deployable structure 100 is brought into the deployed state, the first urging member 136 urges the first member 132 (first support portion 132a in particular) relatively to the rear end side with respect to the first structure 111, whereby the first member 132 slides to the rear end side in the inside of the first structure 111. In other words, the first urging member 136 urges the first bracket 111b in the first structure 111 to the front end side with respect to the first member 132 and the link member 134a. The first member 132 slides to the rear end side with respect to the first structure 111, and thereby a part of the hinge unit 130 sinks into the inside of the first structure 111. Thereby, as shown in FIG. 3B, the first panel 111a and the second panel 112a deploy planarly with respective end surfaces abutting on each other without gaps. Note that instead of the present embodiment, a small gap may occur between an end surface of the first panel 111a and an end surface of the second panel 112a.

Note that the first member 132 may start to slide in the inside of the first structure 111, after the deployable structure 100 completely transitions to the deployed state, or during the deployment operation of the deployable structure 100.

In the inside of the first structure 111, a cavity portion 110j is provided adjacently to a rear end side of the first bracket 111b. A depth direction of the cavity portion 110j is the sliding direction of the first member, that is, a front-rear end direction of the first bracket 111b. In the present embodiment, a length in the extending direction of the first member 132 in the cavity portion 110j is a length equal to or more than a sliding distance during transition of the first member 132 from the folded state to the deployed state. Specifically, the length in the extending direction of the first member 132 in the cavity portion 110j is equal to or more than a length in a long axis direction of the link member 134a. This prevents sliding of the first member 132 from being inhibited by the first member 132 that slides to the rear end side interfering with an internal structure of the first panel 111a.

Here, in the solar cell paddle described in Japanese Laid-open patent publication No. H10-147298, the deployment hinge (4) is disposed between the solar panels (1) in the deployed state, whereby a gap occurs between the solar panels (1), and a continuous plane cannot be obtained.

When the deployable structure 100 in the present embodiment transitions from the folded state to the deployed state, the first member 132 moves to the rear end side in the inside of the first structure 111, and a part of the hinge unit 130 disposed between the first structure 111 and the second structure 112 sinks into the inside of the first structure 111. As a result, the first structure 111 and the second structure 112 move closer to each other. Thereby, a gap that occurs between the first structure 111 and the second structure 112 can be made small, and continuity of the plane formed by the first structure 111 and the second structure 112 can be improved.

Further, the deployable structure (foldable mobile terminal (1)) disclosed in Japanese Laid-open patent publication No. 2011-119830 needs to be provided with the casings (3, 5) in the outer periphery of the deployable structure, and design in the outer periphery of the deployable structure is restricted. In the present embodiment, the structures 110 are connected on the end edge portions 110c that are close to each other in the deployed state. In the deployable structure 100 of the present embodiment, the first support portion 132a is disposed in the inside of the first structure 111, and does not protrude to the outside from the side end surface 110b of the first structure 111. That is to say, the hinge unit 130 is disposed in only the inside of the first structure 111, the inside of the second structure 112, and between the first structure 111 and the second structure 112, and the hinge unit 130 does not protrude to the outer periphery of the deployable structure 100 in the deployed state. Accordingly, in addition to being able to reduce the size of the deployable structure 100 without being subject to design restrictions on the outer periphery of the deployable structure 100, still other structures 110 that perform deployment operation, decorations or the like can be provided on the outer periphery of the deployable structure 100. Thereby, three or more panels can be linearly coupled without gaps as described in a third embodiment.

The first structure 111 and the second structure 112 each forms a plate shape having the main surface 110a and the side end surface 110b. Here, the plate shape means that a thickness dimension is small with respect to a width dimension and a depth dimension. The first structure 111 and the second structure 112 need not to have a solid structure and may have a hollow structure. For example, the first structure 111 and the second structure 112 may be each formed of only a frame configuring an outer shape of the first structure 111 or the second structure 112. In the deployed state, the first structure 111 and the second structure 112 are disposed side by side with each other with the facing side end surfaces 110d that are the side end surfaces located at the end edge portions facing each other. The facing side end surfaces 110d mean the side end surfaces 110b on a side where the first structure 111 and the second structure 112 face each other, of four side end surfaces of the first structure 111 and the second structure 112 that are disposed side by side in the deployed state. Here, side by side means that the first structure 111 and the second structure 112 are disposed by being lined up with the side end surfaces 110b close to each other. In the present embodiment, in the deployed state, the first panel 111a and the second panel 112a are disposed in mirror symmetry to each other, and the facing side end surfaces 110d are disposed parallel to each other, but the present invention is not limited to this. The first member 132 is connected to the facing side end surface 110d of the first structure 111, and the second member 134 is connected to the facing side end surface 110d of the second structure 112.

Here, Japanese Laid-open patent publication No. H07-187089 discloses a two-dimensional deployable structure that is mounted on an artificial satellite as an example of the deployable structure 100. In the two-dimensional deployable structure, a plurality of square planar panels (6) are disposed clockwise, and are coupled to one another by hinges (3) into which torsion coil springs (8) are incorporated being attached to front surfaces or back surfaces of the square planar panels (6). The two-dimensional deployable structure is folded by alternately folding a plurality of hinges (3) that are lined up clockwise, into mountain shapes or valley shapes, and thereby an envelope volume of one sheet can be taken. The hinge (3) rotates by an urging force of the torsion coil spring (8) from the folded state, and thereby the square planar panels (6) transition to the deployed state in which they are lined up on a plane.

In the two-dimensional deployable structure of Japanese Laid-open patent publication No. H07-187089, gaps among the square planar panels (6) can be made relatively small, but components including the rotation shafts (7) of the hinges (3) protrude on the front surfaces or the back surfaces of the square planar panels (6) in the deployed state, and continuity of the plane is lost. If protruded portions occur on panel surfaces, shades due to the protruded portions occur onto the solar cell paddle when the panel is the solar cell panel, for example, and power production efficiency is reduced. Accordingly, it is preferable that a substantially planar portion is provided in a state without a protruded portion protruding from the main surface 110a or with a small, protruded portion in the deployed state as in the deployable structure 100 of the present embodiment.

In contrast to this, in the deployable structure 100 of the preset embodiment, the first member 132 and the second member 134 are each connected to the side end surface 110b of the first structure 111 or the second structure 112. Accordingly, as compared with the case where the first member 132 and the second member 134 are connected on the main surface 110a of the first structure 111 or the second structure 112, a part of the hinge unit 130 is prevented from protruding outside from the main surface 110a of the first structure 111 or the second structure 112. Thereby, in the deployable structure 100 of the present embodiment, the plane with a small, protruded portion or without a protruded portion can be obtained in the deployed state.

In the folded state illustrated in FIGS. 1A and 1B, the rotation shaft 138 protrudes outside from the facing side end surface 110d of the first structure 111. That is to say, the rotation shaft 138 protrudes to the outside of the first structure 111 from the side end surface 110b of the first structure 111, and a shaft center of the rotation shaft 138 is located outside of the first structure 111 from the facing side end surface 110d. In the deployed state, the rotation shaft 138 sinks into the inside of the first structure 111 from the facing side end surface 110d. Here, the rotation shaft 138 sinking into the inside of the first structure 111 from the facing side end surface 110d means that at least the shaft center of the rotation shaft 138 enters an envelope volume of the first structure 111. For example, when the shaft center of the rotation shaft 138 is on the rear end side from the end surface of the first bracket 111b, the rotation shaft 138 is assumed to sink into the inside of the first structure 111 from the facing side end surface 110d.

As a result that the rotation shaft 138 that is disposed outside of the first structure 111 from the facing side end surface 110d is accommodated inside of the first structure 111, whereby the first structure 111 and the second structure 112 move closer to each other, and a gap between the structures 110 can be reduced.

The first structure 111 has an accommodation recessed portion 111c. The accommodation recessed portion 111c accommodates the first member 132 slidably in the predetermined sliding direction. Specifically, the accommodation recessed portion 111c is formed in the first bracket 111b and has an opening portion 111h in the facing side end surface 110d. A depth direction of the accommodation recessed portion 111c is the sliding direction of the first member 132, that is, the front-rear end direction of the first bracket 111b. In the folded state, the link member 134a is disposed to cross the sliding direction of the first member 132. That is to say, the link member 134a is disposed at an angle larger than 0 degrees and smaller than 180 degrees to the sliding direction. The sliding direction of the first member 132 is the extending direction of the first shaft portion 132b in the first member 132. When the folded state transitions to the deployed state, the link member 134a rotates around the rotation shaft 138 with respect to the first member 132, and the second member 134 (link member 134a) and the first member 132 line up on a straight line.

The first member 132 slides in the inside of the first structure 111, and thereby at least a part of the second member 134 (link member 134a) and the rotation shaft 138 are accommodated inside of the accommodation recessed portion 111c.

Sliding refers to changing a position while at least a part is in contact with another member. The first member 132 moves to the rear end side while a part thereof is in contact with the inside of the first structure 111 (first bracket 111b). In the present embodiment, a shape and a size of the first bearing portion 132c of the first member 132 viewed from the extending direction, and a shape and a size of the opening portion 111h of the accommodation recessed portion 111c viewed from the extending direction are substantially the same. The opening portion 111h of the accommodation recessed portion 111c mentioned here refers to a region on the outer side (lower side in FIG. 1B) from an imaginary edge 111e (see FIG. 1B) described later, of an opening region on the front end side of the accommodation recessed portion 111c. In the opening portion 111h of the accommodation recessed portion 111c, a space region (retraction space 111i in FIG. 1B) that is subjected to round chamfering by the sliding surface 110e is continuously provided. That is to say, the retraction space 111i is continuously connected to the inner side (upper side in FIG. 1B) of the opening portion 111h. Further, the shape and the size of the first shaft portion 132b viewed from the extending direction of the first member 132, and the shape and the size of the insertion hole 111g of the first bracket 111b viewed from the extending direction are substantially the same. Thereby, when the first member 132 slides, the first bearing portion 132c contacts the first member sliding contact surface 111d that is a part of a peripheral surface that defines the accommodation recessed portion 111c of the first structure 111, and the first shaft portion 132b contacts a peripheral wall surface that defines the insertion hole 111g in the first structure 111. In this way, when the first member 132 slides, the first member 132 is in contact with the first structure 111 in two spots that are the first shaft portion 132b and the first bearing portion 132c. Accordingly, the first member 132 can slide in a desired sliding direction (front-rear end direction) without laterally deviating in the inside of the first structure 111. Since in the present embodiment, the first shaft portion 132b is separated from the first member sliding contact surface 111d of the accommodation recessed portion 111c without contacting it, friction of the first member 132 to the first structure 111 is suppressed when the first member 132 slides. In this way, when the first member 132 slides in the inside of the first structure 111, the entire first member 132 does not have to be in contact with the first structure 111.

The first member 132 and the link member 134a line up on the straight line, whereby the thickness dimension of the hinge unit 130 is reduced, and it becomes easy to accommodate the hinge unit 130 within the thickness dimension of the first structure 111 in the deployed state. This can restrain the hinge unit 130 from protruding from the main surface 110a of the first structure 111.

Further, in addition to the rotation shaft 138, at least a part of the link member 134a is also accommodated in the inside of the first structure 111, and thereby a gap that occurs between the first structure 111 and the second structure 112 can be further decreased. In the deployed state of the preset embodiment, the entire link member 134a and the second rotation shaft 134b are accommodated in the inside of the first structure 111. Thereby, in FIGS. 3A and 3B, the facing side end surfaces 110d of the first structure 111 and the second structure 112 contact each other, and the gap occurring between the first structure 111 and the second structure 112 is infinitesimally small.

In the deployed state shown in FIGS. 3A and 3B, the first panel 111a and the second panel 112a abut on each other without gaps between the end surfaces. Thereby, movement of the link member 134a to the rear end side stops. That is to say, the deployment operation of the deployable structure 100 ends by the first structure 111 and the second structure 112 abutting on each other on the side end surfaces 110b. Accordingly, the first panel 111a and the second panel 112a are adjacent to each other without gaps in the deployed state. At this time, the first support portion 132a of the first member 132 does not reach a wall surface on the rear end side that defines the cavity portion 110j in the first structure 111 (first bracket 111b). In other words, the first support portion 132a is located at a position separated to the front end side with respect to the wall surface. Further, in other words, a length by which the first member 132 is retractable from the folded state (distance between the first support portion 132a in the folded state and the wall surface on the rear end side defining the cavity portion 110j) is larger than a length by which the first member 132 actually moves to the rear end side by the urging force of the first urging member 136 during the deployment operation. However, instead of the present embodiment, the deployment operation may end by the first bearing portion 132c of the first member 132 abutting on the wall surface on the rear end side that defines the cavity portion 110j in the first structure 111.

In the present embodiment, in the deployed state, the link member 134a is in contact with both the first member sliding contact surface 111d and a surface on the outer side (lower side in FIG. 3B) in the accommodation recessed portion 111c. That is to say, a dimension in the thickness direction of a part of the link member 134a sandwiched between the first member sliding contact surface 111d and the surface on the outer side of the accommodation recessed portion 111c, and a dimension in the thickness direction of the accommodation recessed portion 111c are substantially the same. For this reason, rotation of the link member 134a to the first member 132 is locked by the accommodation recessed portion 111c, and in the deployed state, rotation of the first member 132 and the link member 134a stops. Thereby, it is possible to maintain deployment of the link member 134a and the first member 132 while eliminating a need of a deployment maintaining means for maintaining the deployed state of the link member 134a and the first member 132. Here, the first member sliding contact surface 111d is a surface on the inner side (upper side in FIG. 3B) with which the first member 132 (first bearing portion 132c) slides in contact in the accommodation recessed portion 111c.

As shown in FIG. 1B, the first structure 111 has the sliding surface 110e that smoothly continues to the accommodation recessed portion 111c. The sliding surface 110e is a surface formed by applying round chamfering to the imaginary edge 111e of the opening portion 111h that is a part of the front end side of the accommodation recessed portion 111c in the first structure 111. The sliding surface 110e is a surface that is continuously formed without having a step between the first member sliding contact surface 111d and the sliding surface 110e. The imaginary edge 111e mentioned here is a side that is located on the inner side of sides of a quadrilateral configuring the opening portion 111h of the accommodation recessed portion 111c if round chamfering is not done on the imaginary edge 111e.

The link member 134a transitions to the deployed state from the folded state while sliding in contact with the sliding surface 110e. Specifically, the link member 134a transitions to the deployed state as follows. In the folded state, the first urging member 136 applies an outward urging force to the first structure 111 and the first support portion 132a in a direction in which both of them are separated from each other. By the urging force of the first urging member 136 to the first structure 111, the first structure 111 pushes the link member 134a to the front end side in a region (pushing edge 111f described later) on the inner side from the first member 132 that is a region where the first structure 111 and the link member 134a contact each other in the first structure 111. Further, by the urging force of the first urging member 136, the first member 132 slides to the rear end side with respect to the first structure 111. When the first member 132 slides to the rear end side, an end portion on a rotation shaft 138 side in the link member 134a is pulled to the rear end side. Thereby, the link member 134a rotates in a direction to transition from the folded state to the deployed state (counterclockwise direction in FIG. 1B) around the rotation shaft 138 with respect to the first member 132.

Note that when a hold release mechanism (not illustrated) is operated to release a restraint of the first panel 111a and the second panel 112a, the first member 132 and the link member 134a automatically start to rotate by the outward urging force of the first urging member 136. Further, when the link member 134a starts to rotate with respect to the first member 132, the link member 134a is pulled into the retraction space 111i while sliding in contact with the sliding surface 110e, and one end portion on the rotation shaft 138 side in the link member 134a further starts to sink into the accommodation recessed portion 111c. That is to say, the link member 134a rotates while the link member 134a is accommodated in the inside of the first structure 111.

In the folded state or a process of transitioning to the deployed state from the folded state, the region of the first structure 111 that pushes the link member 134a to the front end side may be a surface, or substantially a line. In the present embodiment, the first structure 111 (first bracket 111b) pushes out the link member 134a to the front end side by the pushing edge 111f formed to be substantially linear. The pushing edge 111f is the side on the inner side of the sides configuring the surface on the front end side in the first structure 111 (first bracket 111b), and is a ridgeline on which the bent sliding surface 110e terminates on the front end side. In this way, a region (pushing edge 111f or a region including the pushing edge 111f) of the first structure 111 that pushes the link member 134a is located on an innermost side of the first structure 111. By pushing the link member 134a to the front end side in the region separated to the inner side from the rotation shaft 138 in the link member 134a in this way, it is possible to apply large moment to the link member 134a, and to start rotation of the link member 134a to the first member 132 more easily. Further, the region of the first structure 111 that pushes the link member 134a preferably has a small dimension in the thickness direction of the first structure 111. For example, it is preferable that the dimension in the thickness direction in the region of the first structure 111 that pushes the link member 134a is less than half a distance in the thickness direction between the pushing edge 111f and the imaginary edge 111e.

In the present embodiment, the surface on which the link member 134a and the first structure 111 (first bracket 111b) contact each other on the inner side from the first member 132 is substantially only the pushing edge 111f. Thereby, the first structure 111 pushes out the link member 134a to the front end side at a position that is most separated from the rotation shaft 138, and therefore larger moment can be applied to the link member 134a from the first structure 111. In order that the first structure 111 (first bracket 111b) may push the link member 134a with only the pushing edge 111f, a radius at a time of applying round chamfering to the imaginary edge 111e may have a length equal to or more than a distance between the imaginary edge 111e and the pushing edge 111f.

When the deployable structure 100 further deploys, an intermediate portion of the link member 134a and a part on a second rotation shaft 134b side are gradually brought into the accommodation recessed portion 111c through the retraction space 111i. The link member 134a rotates with respect to the first member 132 while sinking into the accommodation recessed portion 111c, and thereby a volume through which the deployable structure 100 passes when transitioning to the deployed state from the folded state is decreased. Thereby, it is possible to prevent the deployable structure 100 from interfering with other components during the deployment operation.

Further, the link member 134a sinks into the accommodation recessed portion 111c while sliding in contact with the sliding surface 110e, and thereby it is possible to control rotation of the link member 134a with respect to the first member 132. Specifically, when the link member 134a rotates with respect to the first member 132 as shown in FIG. 2B, the rotation shaft 138 enters into the envelope volume of the first bracket 111b, and the link member 134a and the sliding surface 110e contact each other. As a result that the link member 134a contacts the sliding surface 110e in the first structure 111, rotation of the link member 134a in a reverse transition direction (clockwise direction in FIG. 2B) from the deployed state to the folded state is restricted by the first structure 111. Thereby, rotation of the link member 134a during the deployment operation is limited to only the direction to transition to the deployed state. Further, when the rotation shaft 138 enters into the envelope volume of the first bracket 111b, rotation of the link member 134a (in particular, the rotation in the counterclockwise direction in FIG. 2B) is restricted by the surface on the outer side of the accommodation recessed portion 111c. Therefore, during the deployment operation, excessive rotation of the link member 134a is prevented, and in the deployed state, the state in which the link member 134a is deployed linearly with respect to the first member 132 is maintained.

Here, if the first structure 111 does not have the sliding surface 110e in the accommodation recessed portion 111c, the link member 134a cannot be brought into the accommodation recessed portion 111c immediately even if deployment is started from the folded state, and the link member 134a starts to slide to the rear end side finally at a time point when the link member 134a and the first member 132 line up on a straight line in the deployed state. The link member 134a and the first member 132 that line up on the straight line abruptly slide in the accommodation recessed portion 111c by the urging force of the first urging member 136. Therefore, an impact force received by the side end surfaces 110b of the first structure 111 and the second structure 112 at a time of end of the deployment operation becomes large. As compared with this, when the first structure 111 has the sliding surface 110e as in the present embodiment, the link member 134a slides to the rear end side little by little while rotating, so that the impact force that occurs at the time of the end of the deployment can be decreased.

In the present embodiment, the width dimension of the link member 134a is smaller than the width dimension of the first bearing portion 132c. Further, the width dimension of the sliding surface 110e is equal to or larger than the width dimension of the link member 134a and is smaller than the width dimension of the first bearing portion 132c. Thereby, the first bearing portion 132c is restricted from deviating to the inner side from the accommodation recessed portion 111c, and the first member 132 can slide parallel with the first panel 111a.

The deployable structure 100 of the present embodiment has an assistance urging member 135 in addition to the first urging member 136. The assistance urging member 135 applies an urging force to the deployable structure 100 so that the first member 132 and the second member 134 may transition from the folded state to the deployed state. The assistance urging member 135 is a different member from the first urging member 136. Here, applying the urging force to the deployable structure 100 means applying the urging force to a part of the deployable structure 100.

A position and a direction in which the assistance urging member 135 applies the urging force to the deployable structure 100 are not particularly limited as long as the first member 132 and the second member 134 transition from the folded state to the deployed state. As the specific assistance urging member 135, a torsion spring is illustrated. The torsion spring is disposed coaxially with the rotation shaft 138 and urges the link member 134a and the first bearing portion 132c in the deployment direction (counterclockwise in FIG. 1B). The assistance urging member 135 like this may be provided inside of the rotation shaft 138 or a periphery of the rotation shaft 138, or may be disposed between the first member 132 and the link member 134a.

As another example of the assistance urging member 135, a same type of mechanism as the wire pulling mechanism described above as the modification of the first urging member 136 can be cited. When the wire pulling mechanism is used as the assistance urging member 135, one end of a wire is coupled to one of the first panel 111a or the second panel 112a, and a pulling unit is installed at the other one of them. By pulling the wire by the pulling unit, both the first panel 111a and the second panel 112a are urged in a direction in which they are separated from each other. For example, when a rear end side of the first panel 111a is fixed to a system (for example, a spacecraft body or a boom yoke), the wire is coupled to a rear end side of the second panel 112a, and by pulling the wire in the deployment direction (upward in FIG. 1B), the first member 132 and the link member 134a (second member 134) transition to the deployed state.

As a result that the urging force is applied to the deployable structure 100 so that the link member 134a (second member 134) and the first member 132 transition from the folded state to the deployed state by the assistance urging member 135, automatic rotation of the first member 132 and the link member 134a by the first urging member 136 is assisted. Thereby, automatic rotation of the first member 132 and the link member 134a can be reliably performed.

In the preset embodiment, the deployable structure 100 further has the second assistance urging member 139. The second assistance urging member 139 in the present embodiment applies an urging force to the deployable structure 100 so as to cause the second structure 112 and the link member 134a to transition from the folded state to the deployed state, and assists rotation of the second structure 112 and the link member 134a. As the specific second assistance urging member 139, it is possible to illustrate a torsion spring that is disposed coaxially with the second rotation shaft 134b and urges the second structure bearing portion 112d in the deployment direction (counterclockwise in FIG. 1B) with respect to the link member 134a. The second assistance urging member 139 like this may be provided inside of the second rotation shaft 134b or a periphery of the second rotation shaft 134b, or may be disposed between the shaft member 134c and the link member 134a.

In order that the deployable structure 100 may transition from the folded state to the deployed state, the first member 132 and the link member 134a rotate around the rotation shaft 138, and the second structure 112 and the link member 134a rotate around the second rotation shaft 134b.

If a rotational force around the second rotation shaft 134b is sufficiently small as compared with a rotational force around the rotation shaft 138, there is a possibility that rotation of the second structure 112 and the link member 134a will be locked by the first structure 111 and the deployable structure 100 will not deploy normally. Specifically, when the rotational force around the second rotation shaft 134b is small enough to be able to be ignored as compared with the rotational force around the rotation shaft 138, the first member 132 and the link member 134a are in the deployed state before the second structure 112 and the link member 134a start to rotate, and the side end surface 110b of the first structure 111 and the main surface 110a of the second structure 112 can abut on each other. The second structure 112 that rotates in a direction to transition to the deployed state with respect to the link member 134a in this state is locked by the first structure 111, and transition to the deployed state of the deployable structure 100 is inhibited.

In order that rotation of the second structure 112 to the link member 134a may not be restricted by the first structure 111, and the deployable structure 100 may deploy normally, it is preferable that the second structure 112 and the link member 134a are deployed to a such an extent that an angle between the second structure 112 and the link member 134a is equal to or more than a predetermined angle, at a timing at which the first structure 111 slides until the first structure 111 contacts the second structure 112. Therefore, the urging force of the second assistance urging member 139 can be set so that the rotational force around the second rotation shaft 134b becomes so large that the angle of the second structure 112 and the link member 134a becomes equal to or larger than the above-described predetermined angle before that timing.

Here, the predetermined angle is a threshold of a deployment angle of the second structure 112 when the first structure 111 slides by the first urging member 136, and the first structure 111 contacts the second structure 112. If the deployment angle is equal to or larger than the threshold, the second structure bearing portion 112d is pulled to the first structure 111 side so as to be brought into the first structure 111 by the urging force of the first urging member 136 and thereby the second structure 112 transitions to the deployed state. On the other hand, if the deployment angle is smaller than the threshold, the first structure 111 urges the main surface 110a of the second structure 112 by the urging force of the first urging member 136, and thereby the second structure 112 transitions to the folded state. The predetermined angle is an angle that serves as a boundary between whether the second structure 112 transitions toward the deployed state or transitions toward the folded state. The above-described predetermined angle varies due to various factors. For example, the above-described angle is 135 degrees.

Further, either the rotational force around the second rotation shaft 134b or the rotational force around the rotation shaft 138 may be larger or smaller. For example, when the assistance urging member 135 and the second assistance urging member 139 respectively assist the rotation of the first member 132 and the link member 134a, and the rotation of the link member 134a and the second structure 112 as described above, the rotational force around the second rotation shaft 134b applied by the second assistance urging member 139 may be larger or smaller than a total of the rotational force applied by the first urging member 136 around the rotation shaft 138 and the rotational force applied by the assistance urging member 135 around the rotation shaft 138. Further, the rotational force applied by the second assistance urging member 139 around the second rotation shaft 134b may be larger than the rotational force applied by the assistance urging member 135 around the rotation shaft 138. Thereby, when the first structure 111 deploys and slides to contact the second structure 112, the second structure 112 is easily made to have the deployment angle equal to or larger than the above-described predetermined angle.

When the assistance urging member 135 is the mechanism that urges the first panel 111a and the second panel 112a in the direction to be separated from each other by the wire as described above, a need of the second assistance urging member 139 can be eliminated. This is because when both the first panel 111a and the second panel 112a are urged in the direction in which they are separated from each other, the first member 132 and the link member 134a rotate, and rotation of the second structure 112 and the link member 134a is also performed.

In the present embodiment, the rotational force around the rotation shaft 138 applied to the link member 134a by the first urging member 136 is larger than the rotational force applied by the assistance urging member 135 around the rotation shaft 138. Thereby, the link member 134a can rotate while sliding on and in contact with the sliding surface 110e without separating from the sliding surface 110e.

The deployable structure 100 can have the deployment maintaining unit (not illustrated) for maintaining the state in which the link member 134a and the second structure 112 are deployed. Further, the deployable structure 100 may include the deployment maintaining unit (not illustrated) that maintains the deployed state of the first member 132 and the link member 134a, in place of the method for restricting the rotation of the first member 132 and the link member 134a by the accommodation recessed portion 111c in the present embodiment, or in addition to the method.

For example, a locking portion for restricting an upper limit of the rotation angle of each other may be provided, at the first structure 111 or the link member 134a, or the link member 134a or the second structure 112. Thereby, it is possible to prevent the first member 132 and the link member 134a, or the link member 134a and the second structure 112 from rotating by 180 degrees or more.

Further, in order to prevent transition from the deployed state to the folded state, the deployable structure 100 may be provided with a latch structure by which the first member 132 and the link member 134a, or the link member 134a and the second structure 112 are locked when the first member 132 and the link member 134a, or the link member 134a and the second structure 112 reach a rotation angle equal to or larger than a predetermined angle from an initial state (folded state). Thereby, reverse rotation in the folding direction of the first member 132 and the link member 134a, or the link member 134a and the second structure 112 is restricted. Besides, when the assistance urging member 135 or the second assistance urging member 139 is a torsion spring, part of an elastic restoring force may still remain in the assistance urging member 135 or the second assistance urging member 139 even after the two members are aligned in a straight line. An amount of twist in the folded state can be set in advance so that the first member 132 and the link member 134a, or the link member 134a and the shaft member 134c still have a rotational force by which they rotate by 180 degrees or more even in the deployed state.

Further, part of the elastic restoring force may be made to still remain in the first urging member 136 even after the first structure 111 and the second structure 112 abut on each other in the deployed state. That is to say, a compression length of the first urging member 136 in the initial state can be set so that the first urging member 136 urges the first support portion 132a to the rear end side with respect to the first structure 111 even in the deployed state shown in FIG. 3B. Thereby, the side end surfaces 110b of the first structure 111 and the second structure 112 are brought into a state in which they are pressed to each other by the urging force remaining in the first urging member 136, so that the deployable structure 100 is well maintained in the deployed state.

### Second Embodiment

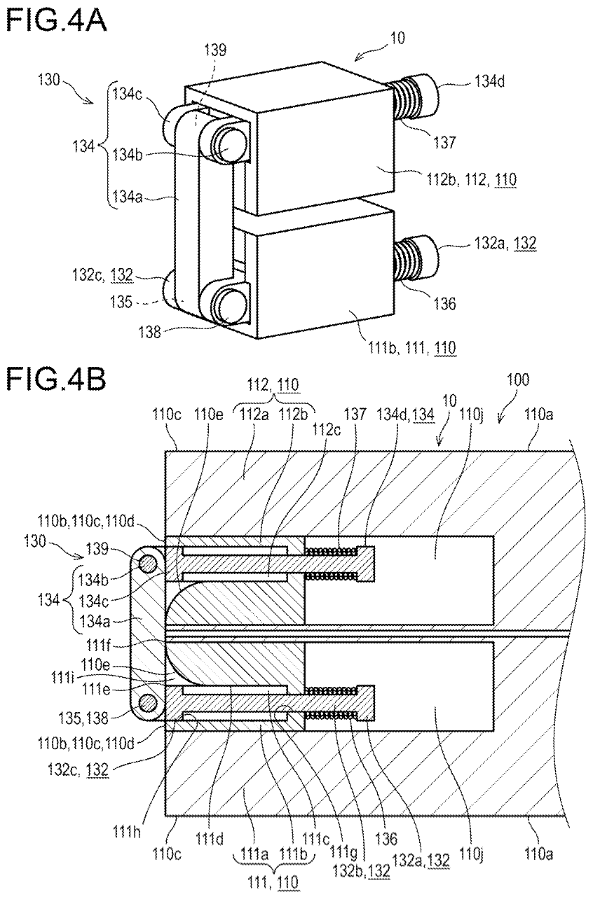

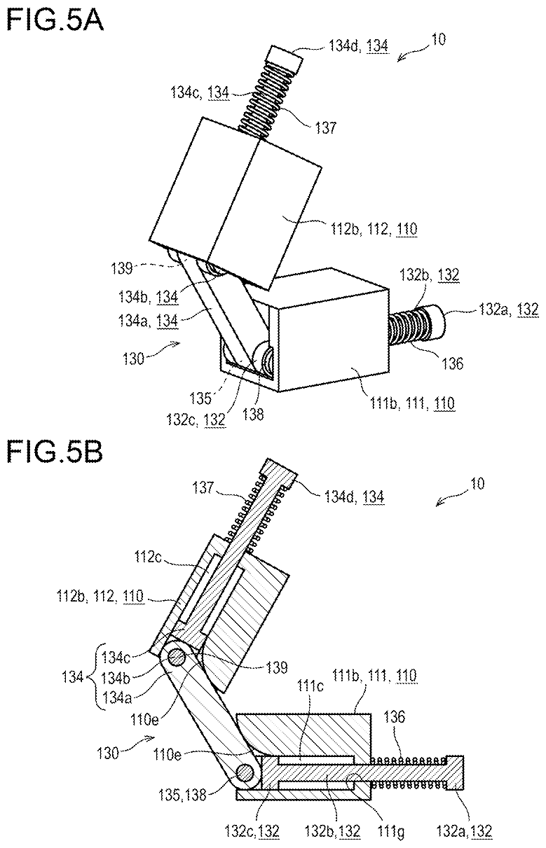

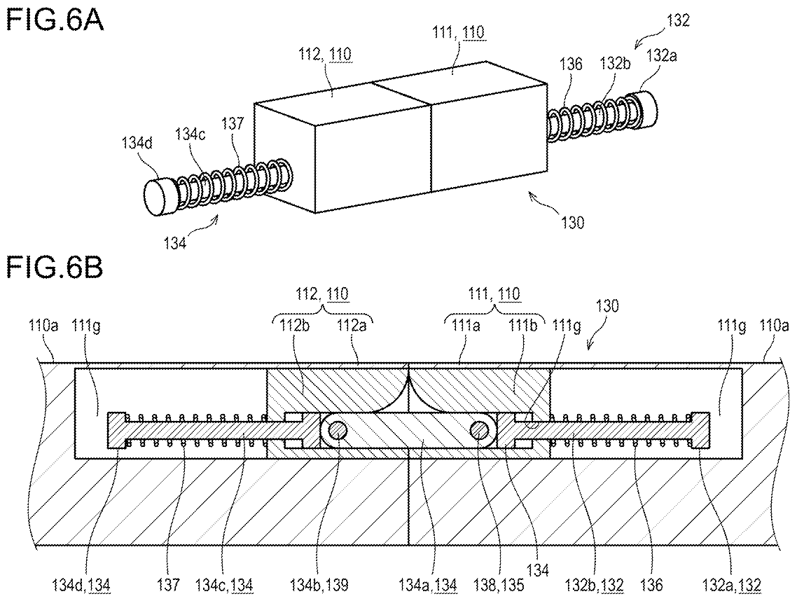

FIGS. 4A, 4B, 5A, 5B, 6A and 6B are schematic views for explaining a deployment sequence of a deployable structure 100 of the second embodiment. FIGS. 4A and 4B are explanatory views of the deployable structure 100 of the second embodiment in a folded state. FIGS. 5A and 5B are explanatory views of the deployable structure 100 of the second embodiment during deployment operation. FIGS. 6A and 6B are explanatory views of the deployable structure 100 of the second embodiment in a deployed state. In FIGS. 4A, 5A, 5B, and 6A, a first panel 111a and a second panel 112a are not shown.

As in the first embodiment, in a structure 110, a first member 132, a shaft member 134c, a first urging member 136, and a second urging member 137, a link member 134a side is referred to as “front end side”, and a first support portion 132a or second support portion 134d side is referred to as “rear end side”. Further, in a first structure 111 and a second structure 112, when the first structure 111 and the second structure 112 face each other in the folded state, a direction toward each other is referred to as “inner side”, and an opposite direction thereof is referred to as “outer side”.

The present embodiment differs from the first embodiment in that not only the first structure 111 is urged toward the second structure 112, but also the second structure 112 is urged toward the first structure 111.

A hinge structure 10 in the folded state of the present embodiment has mirror symmetry in a plane passing through a center in an extending direction of a link member 134a and orthogonal to shaft portions of the link member 134a. That is to say, the first structure, the first member 132 and the first urging member 136, and the second structure 112, the shaft member 134c and the second urging member 137 are structures of mirror symmetry. However, the hinge structure 10 is not limited to mirror symmetry, and the first structure, the first member 132 and the first urging member 136, and the second structure 112, the shaft member 134c and the second urging member 137 may differ from each other in shape and size.

The first structure 111 and the second structure 112 are connected by a hinge unit 130. The first member 132 is inserted through an end edge portion 110c of the first structure 111, and the first member 132 slides inside of the first structure 111 in an extending direction of the first member 132. The first member 132 has a support portion (first support portion 132a).

The second member 134 has a second rotation shaft 134b, the link member 134a, and the shaft member 134c. The link member 134a and the shaft member 134c are rotatably connected to each other via the second rotation shaft (second rotation shaft 134b). The link member 134a is one or a plurality of members each having a rotation shaft 138 and the second rotation shaft 134b at both end portions. The shaft member 134c has the second support portion (second support portion 134d). The shaft member 134c is slidably connected to the second structure 112. That is to say, the shaft member 134c is inserted through an end edge portion 110c of the second structure 112 and slides inside of the second structure 112 in an extending direction of the shaft member 134c. The shaft member 134c is a long object, and the extending direction of the shaft member 134c is a long length direction of the shaft member 134c.

A second urging member (second urging member 137) is disposed between the second support portion 134d and the second structure 112. The second urging member 137 applies an outward urging force in the extending direction of the second urging member 137 to the second structure 112 and the second support portion 134d. The second support portion 134d is a part of the shaft member 134c for applying the urging force of the second urging member 137 to the shaft member 134c. In the present embodiment, the second support portion 134d is a part made by forming an end portion of the shaft member 134c into a flange shape.

The shaft member 134c is combined with the link member 134a by the second rotation shaft 134b with the other end opposite from the second support portion 134d as a bearing portion. The link member 134a and the shaft member 134c rotate around the second rotation shaft 134b.

Note that the present invention also includes aspects of various modifications, alterations and the like as illustrated in the first embodiment without being limited to an aspect of the present embodiment. For example, the second support portion 134d may be formed at an end portion of the shaft member 134c as shown in the present embodiment or may be formed in a middle portion in a length direction of the shaft member 134c. Also, the second urging member 137 may be an elastic member such as a coil spring or may be a mechanism that applies a driving force between the second structure 112 and the shaft member 134c. As the mechanism like this, for example, the wire pulling mechanism that is described above as the modification of the assistance urging member 135 can be cited. In this case, the second support portion 134d is a part to which the mechanism is coupled, in the shaft member 134c. Specifically, by coupling one end of the wire to either one of the second support portion 134d or the second structure 112, installing a pulling unit at the other one, and pulling the other end of the wire, a positional relationship of the shaft member 134c and the second structure 112 relatively changes to assist transition to a deployed state.

At a rear end side of the second structure 112 (second bracket 112b), an insertion hole for the shaft member 134c to penetrate through in a front-rear end direction is formed. In the present embodiment, the second structure 112 and the second support portion 134d have shapes and sizes that respectively include pressing surfaces at both ends in the second urging member 137 when viewed in an axial direction of the shaft member 134c. Thereby, the urging force of the second urging member 137 is efficiently applied to the second support portion 134d and the second structure 112.

When the folded state transitions to the deployed state, the first urging member 136 urges and moves the first structure 111 toward the second structure 112, and the second urging member 137 urges and moves the second structure 112 toward the first structure 111. Thereby, as shown in FIGS. 5A, 5B, 6A, and 6B, a part of the hinge unit 130 sinks into an inside from an outside of the first structure 111, and another part of the hinge unit 130 sinks into an inside from an outside of the second structure 112.

In the present embodiment, the second structure 112 has a second accommodation recessed portion 112c that opens to a facing side end surface 110d. The second accommodation recessed portion 112c is a recessed portion that accommodates the shaft member 134c slidably in a sliding direction of the shaft member 134c.

As shown in FIG. 4B, the second structure 112 has a sliding surface 110e that smoothly continues to the second accommodation recessed portion 112c.

Next, deployment operation in which the present embodiment transitions from the folded state to the deployed state will be described.

FIG. 4A illustrates the deployable structure 100 in the folded state. A main surface 110a of the first structure 111 and a main surface 110a of the second structure 112 face each other in a state in which the main surfaces 110a overlap each other in a thickness direction. A deployment angle of the deployable structure 100 in FIG. 4A is 0 degrees. The rotation shaft 138 and the second rotation shaft 134b each protrudes outside from the facing side end surface 110d of the first structure 111 or the second structure 112. In the folded state, the link member 134a is disposed to cross the sliding direction of the shaft member 134c.

From the folded state, the first member 132 and the link member 134a rotate around the rotation shaft 138, and the link member 134a and the shaft member 134c rotate around the second rotation shaft 134b. Thereby, the first structure 111 and the second structure 112 change positions relative to each other, and the deployable structure 100 deploys. Specifically, the deployable structure 100 transitions from the folded state to the deployed state as follows.

In the folded state, the first urging member 136 applies an outward urging force in the extending direction of the first urging member 136 to the first support portion 132a and the first structure 111, and the second urging member 137 applies an outward urging force in the extending direction of the second urging member 137 to the second support portion 134d and the second structure 112. By the urging forces by the first urging member 136 and the second urging member 137, the first structure 111 and the second structure 112 respectively push the link member 134a to the front end side. On the other hand, the first member 132 and the shaft member 134c slide to the rear end side relatively to the first structure 111 or the second structure 112 by the urging forces of the first urging member 136 and the second urging member 137. When the first member 132 and the shaft member 134c slide to the rear end side, both ends of the link member 134a to which the first member 132 and the shaft member 134c are coupled are respectively pulled to the rear end side with respect to the first structure 111 and the second structure 112. In other words, the first structure 111 and the second structure 112 are respectively urged by the first urging member 136 or the second urging member 137 and guided by the link member 134a to move in a direction to approach each other. Thereby, the link member 134a rotates in a direction to transition from the folded state to the deployed state (counterclockwise direction in FIG. 4B) around the rotation shaft 138 with respect to the first member 132 and rotates in a direction to transition from the folded state to the deployed state (clockwise direction in FIG. 4B) around the second rotation shaft 134b with respect to the shaft member 134c.

An assistance urging member 135 that applies an urging force to the deployable structure 100 so that the first member 132 and the second member 134 transitions from the folded state to the deployed state assists automatic rotation of the first member 132 and the link member 134a by the urging force of the first urging member 136. In addition, the deployable structure 100 has a second assistance urging member 139 that applies an urging force to the deployable structure 100 so as to cause the link member 134a and the shaft member 134c to transition from the folded state to the deployed state. The second assistance urging member 139 in the present embodiment causes the link member 134a and the shaft member 134c to transition from the folded state to the deployed state unlike the first embodiment. The second assistance urging member 139 assists automatic rotation of the link member 134a and the shaft member 134c by the urging force of the second urging member 137.

When the link member 134a and the first member 132 start to rotate around the rotation shaft 138, the link member 134a starts to sink into the inside of the first structure 111 while sliding in contact with the sliding surface 110e of the first structure 111. Further, when the link member 134a and the shaft member 134c start to rotate around the second rotation shaft 134b, the link member 134a starts to sink into the inside of the second structure 112 while sliding in contact with a sliding surface 110e of the second structure 112.

FIGS. 5A and 5B show the deployable structure 100 during deployment operation of the second embodiment and show a state in which the deployment angle becomes approximately 60 degrees.

In FIGS. 5A and 5B, the first member 132 and the link member 134a, and the link member 134a and the shaft member 134c evenly deploy since the first urging member 136 and the second urging member 137 are urging members having similar urging forces. Instead of this, the first member 132 and the link member 134a, and the link member 134a and the shaft member 134c may not deploy simultaneously. That is to say, in order that the deployable structure 100 may take a predetermined deployment angle, rotation of the first member 132 and the link member 134a, and rotation of the link member 134a and the shaft member 134c may be independent from each other without being synchronized.

FIGS. 6A and 6B show a state in which the deployable structure 100 deploys so that the deployment angle becomes approximately 180 degrees.

When the deployable structure 100 deploys from the folded state to the deployed state, the first structure 111 and the second structure 112 respectively move to the front end side along the first member 132 and the shaft member 134c by the first urging member 136 and the second urging member 137. As a result that the first structure 111 and the second structure 112 move to the front end side, the first structure 111 and the second structure 112 cause at least parts of the hinge unit 130 to sink into the insides of them to accommodate the parts of the hinge unit 130. It is desirable that a part of the hinge unit 130 sinks into the first structure 111 so that the rotation shaft 138 is disposed inside of the first structure 111 from the facing side end surface 110d of the first structure 111. Alternatively, a part of the hinge unit 130 sinks into the second structure 112 so that the second rotation shaft 134b is disposed inside of the second structure 112 from the facing side end surface 110d of the second structure 112. More desirably, the first member 132, the shaft member 134c and the link member 134a line up on a straight line, and a part of the link member 134a and the rotation shaft 138 are accommodated in an accommodation recessed portion 111c of the first structure 111. Further, another part of the link member 134a and the second rotation shaft 134b are accommodated in the second accommodation recessed portion 112c of the second structure 112. In the present embodiment, a part of the link member 134a and the rotation shaft 138 are accommodated in the accommodation recessed portion 111c of the first structure 111, and the other part of the link member 134a and the second rotation shaft 134b are accommodated in the second accommodation recessed portion 112c of the second structure 112.

The first structure 111 and the second structure 112 may start to move, after the deployable structure 100 completely transitions to the deployed state, or during transition of the deployable structure 100 to the deployed state.

In the present embodiment, the second structure 112 is also urged to the first structure 111 side by the second urging member 137, and thereby a length by which the first urging member 136 moves the first structure 111 is shortened as compared with the first embodiment. Thereby, if the lengths in an axial direction of the link member 134a are the same in the first embodiment and the second embodiment, lengths of the first urging member 136 and the first member 132 can be designed to be shorter than those in the first embodiment, and the hinge unit 130 that is embedded in the first structure 111 can be miniaturized.

As shown in FIGS. 6A and 6B, the part of the link member 134a and the rotation shaft 138 are accommodated in the accommodation recessed portion 111c of the first structure 111, and the part of the link member 134a and the second rotation shaft 134b are accommodated in the second accommodation recessed portion 112c of the second structure 112. Thereby, rotation of the first member 132 and the link member 134a, and rotation of the link member 134a and the shaft member 134c are locked by the accommodation recessed portion 111c and the second accommodation recessed portion 112c. Accordingly, it is possible to maintain the deployed state of the first member 132 and the link member 134a, and the link member 134a and the shaft member 134c while eliminating a need of the deployment maintaining unit.

### Third Embodiment

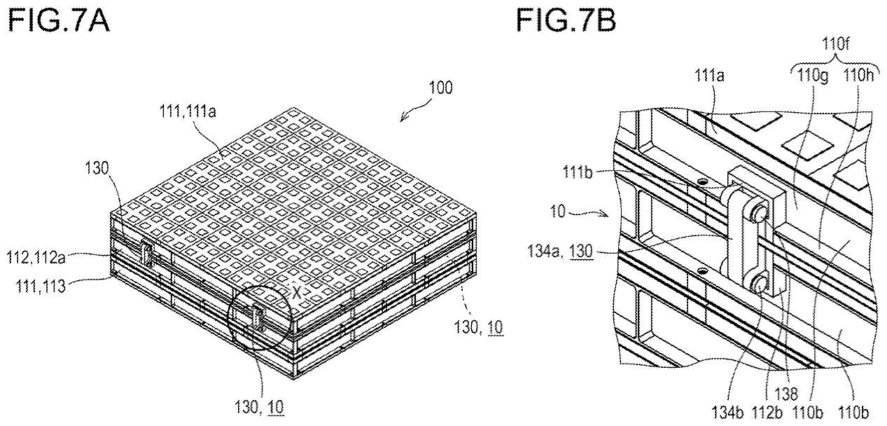

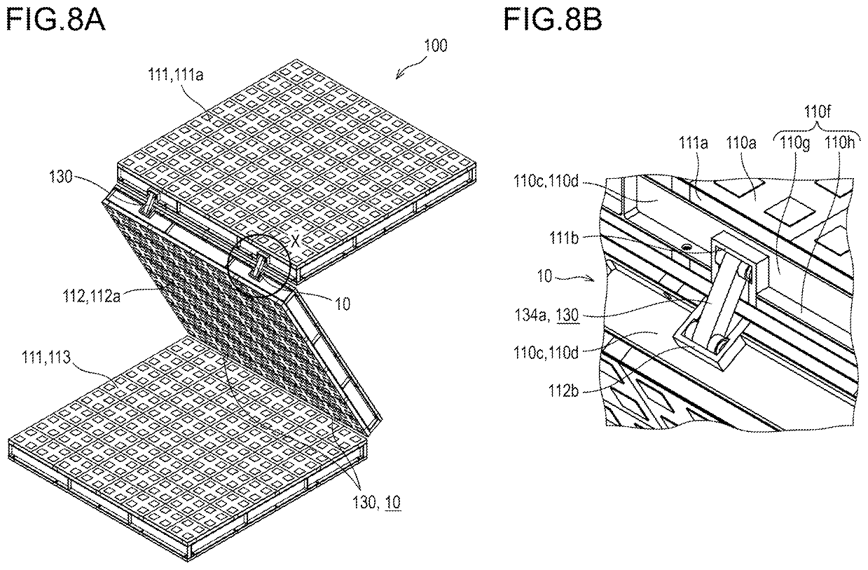

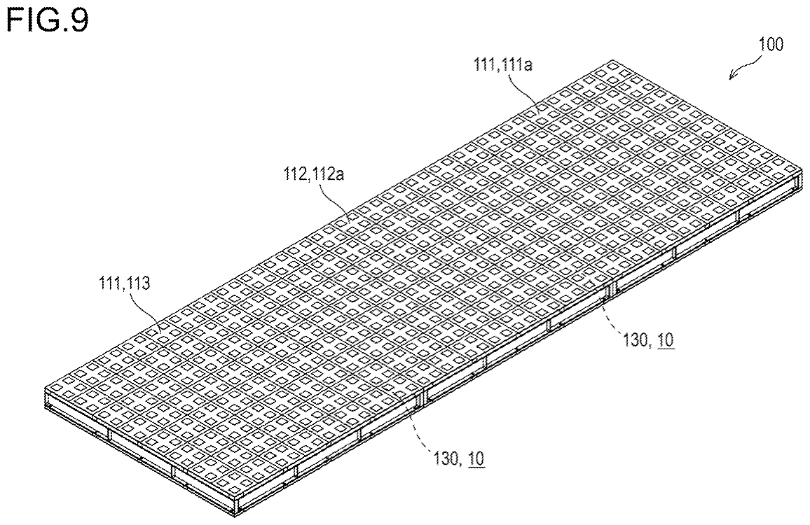

FIG. 7A is a perspective view showing a folded state of a deployable structure 100 of a third embodiment, and FIG. 7B is an enlarged view of a region X of FIG. 7A. FIG. 8A is an explanatory view of the deployable structure 100 of the third embodiment that performs deployment operation, and FIG. 8B is an enlarged view of the region X of FIG. 8A. FIG. 9 is a perspective view showing a deployed state of the deployable structure 100 of the third embodiment.

As in the second embodiment, a hinge unit 130 side is referred to a front end side in a structure 110. Further, in a first structure 111 and a second structure 112, a direction with respect to each other when the first structure 111 and the second structure 112 face each other in a folded state is referred to as “inner side”, and an opposite direction thereof is referred to as “outer side”.

The deployable structure 100 of the present embodiment differs from the second embodiment in that three or more structures 110 are coupled to one another. The deployable structure 100 of the present embodiment is made by connecting three panels (a first panel 111a, a second panel 112a, a third panel 113) linearly as in FIG. 8A by the hinge structure 10 in the second embodiment. In the present embodiment, the first panel 111a and the second panel 112a, and the second panel 112a and the third panel 113 are respectively connected by two sets of hinge structures 10. The panels may be connected with three or more sets of hinge structures 10 or may be connected with a set of hinge structures 10.

Hereinafter, for convenience of explanation, the first panel 111a and the third panel 113 are each sometimes referred to as the first structure 111, and the second panel is sometimes referred to as the second structure 112.

The deployable structure 100 has a plurality of first structures 111 and a plurality of hinge units 130. Shapes of the plurality of first structures 111 and the second structure 112 are each a plate shape having a main surface 110a and side end surfaces 110b. Here, the plurality of first structures 111 are the first panel 111a and a bracket, and the third panel 113 and a bracket. That is to say, the first panel 111a and the third panel 113 each corresponds to the first panel 111a in the first structure 111.

In the deployed state, the plurality of first structures 111 (the first panel 111a, the third panel 113) and the second structure 112 (second panel 112a) are disposed side by side with each other with the side end surfaces 110b of the plurality of structures 111 respectively facing the different side end surfaces 110b of the second structure 112. In the present embodiment, an aspect in which the first panel 111a and the third panel 113 are respectively connected to the side end surfaces facing them of the second panel 112a. Thereby, the first panel 111a, the second panel 112a, and the third panel 113 in the deployed state line up in a straight line. However, instead of the present embodiment, the first panel 111a and the third panel 113 may be connected respectively to adjacent side end surfaces of the second panel. The side end surfaces 110b of the plurality of first structures 111 (the first panel 111a, the third panel 113) and the side end surfaces 110b of the second structure 112 (second panel 112a) are respectively connected by the hinge units 130.

When transitioning from the folded state to the deployed state, the plurality of first structures 111 and the second structure 112 are urged toward each other and move by the first urging members 136 and the second urging members 137, and at least parts in the plurality of hinge units 130 sink into insides from outsides of the plurality of first structures 111.

In the present embodiment, the first panel 111a, the second panel 112a and the third panel 113 are hollow bodies including plate-shaped components on the main surfaces 110a and the side end surfaces 110b. Shapes of the first panel 111a, the second panel 112a and the third panel 113 may be squares, or regular hexagons besides rectangles (oblongs).

The first panel 111a, the second panel 112a and the third panel 113 have side plates 110f on the side end surfaces 110b. The side plate 110f has a recessed surface 110g, and a flange surface 110h that is in contact with the main surface 110a in a long side. In order to enhance rigidity of the structure 110, ribs are provided perpendicularly to the main surface 110a, in the side plate 110f. As shown in FIG. 8A, at least part of the brackets (a first bracket 111b and a second bracket 112b) is provided on the recessed surface 110g. Specifically, a fitting hole (not illustrated) is formed in the recessed surface 110g, and the first bracket 111b is inserted into the fitting hole. A part of a rear end side of the first bracket 111b is embedded into a rear end side of the first panel from the side plate.

The brackets (the first bracket 111b and the second bracket 112b) are provided on the side plates 110f to be in contact with flange surfaces 110h on the inner side in the folded state. That is to say, the first bracket 111b and the second bracket 112b are installed on the inner side in the folded state from a thickness center of the first structure 111 or the second structure 112. Thereby, a length of a link member 134a is designed to be short, and a distance by which the structures 110 are brought closer to each other can be shortened. Further, since the urging members (the first urging member 136 and the second urging member 137) for bringing the structures 110 closer to each other can be designed to be short, the hinge unit 130 can be miniaturized.

As shown in FIG. 7A, in the folded state, a back surface of the first panel 111a and a back surface of the second panel 112a, and a front surface of the second panel 112a and a front surface of the third panel 113 are respectively caused to face each other, and thereby the deployable structure 100 is folded into an N shape. That is to say, in the second panel 112a, in both the facing sides (side end surfaces 110b), the first panel 111a and the third panel 113 are respectively connected by the hinge structures 10, and one of the hinge structures 10 provided on one side of the second panel 112a is folded into a mountain shape, and the hinge structure 10 provided on the other side facing the one side is folded into a valley shape.

The rotation shafts 138 and the second rotation shafts 134b of the hinge units 130 that respectively connect the first panel 111a and the second panel 112a, and the second panel 112a and the third panel 113 protrude laterally outside from the side end surfaces 110b of the first structure 111 (the first panel 111a, the third panel 113) or the second structure 112 (second panel 112a). By urging forces of the first urging members 136 (see FIG. 4A) of the plurality of hinge units 130, the first panel 111a and the third panel 113 start to rotate with respect to the link members 134a, and the second panel 112a starts to rotate with respect to the link members 134a by urging forces of the second urging members 137 (see FIG. 4A).

As shown in FIG. 8A, by the plurality of hinge units 130, the first panel 111a and the second panel 112a, and the second panel 112a and the third panel 113 respectively deploy to each other, and thereby the deployable structure 100 deploys. FIG. 8A shows an aspect in which a deployment angle of the first panel 111a and the second panel 112a during deployment operation, and a deployment angle of the second panel 112a and the third panel 113 are same angles, but the present invention is not limited to this. Rotation of the hinge units 130 connecting the first panel 111a and the second panel 112a, and rotation of the hinge units 130 connecting the second panel 112a and the third panel 113 may not be synchronized.

FIG. 8A shows an aspect in which parts of the hinge units 130 sink into insides of the first structures 111 (the first panel 111a and the third panel 113) and the second structure 112 (second panel 112a) at a same time as transition from the folded state to the deployed state, but the hinge units 130 may start to sink into the first structure 111 or the second structure 112 after transition to the deployed state.

As shown in FIG. 9, in the deployed state, the first panel 111a, the second panel 112a and the third panel 113 are disposed side by side in order. When the deployable structure 100 deploys, the hinge units 130 sink into insides of the first panel 111a and the third panel 113 by the first urging members 136 (see FIG. 4A). Likewise, the hinge units 130 sink into an inside of the second panel 112a by the second urging members 137 (see FIG. 4A). In the present embodiment, the rotation shafts 138 and parts of the link members 134a sink into insides of the first panel 111a and the third panel 113, and the second rotation shafts 134b and other parts of the link member 134a sink into the inside of the second panel 112a. Thereby, the side end surfaces 110b of the first panel 111a and the second panel 112a, and the side end surfaces 110b of the second panel 112a and the third panel 113 abut on each other, and gaps between the first panel 111a and the second panel 112a, and between the second panel 112a and the third panel 113 are infinitesimally small.

Here, when the panels are coupled to each other by the method of Japanese Laid-open patent publication No. H10-147298, there are gaps between the panels in the deployed state, and a continuous plane cannot be obtained. Further, with the method of Japanese Laid-open patent publication No. H07-187089, the two panels can be deployed as a continuous plane without gaps, but when three panels are coupled, protruded portions due to the hinges occur on the front surface and the back surface, and a continuous plane cannot be obtained. By the method of Japanese Laid-open patent publication No. 2011-119830, the two panels can be deployed without gaps, but the casings (3, 5) are required on the outer periphery, so that three panels cannot be deployed without gaps.

In contrast to this, in the present embodiment, at least parts of the hinge units 130 disposed between the structures 110 sink into insides of the structures 110, whereby the panels can be deployed so that the gap between the structures 110 decreases. Further, as a result that the hinge unit 130 is connected to the facing side end surface 110d of the structure 110, the hinge unit 130 can be prevented from protruding outside from the main surface 110a of the structure 110, and the three panels can be deployed as a plane with few protruded portions. Furthermore, since the end edge portions 110c of the structures 110 are connected by the hinge units 130, and the hinge units do not protrude to the outer peripheries of the panels, the three panels can be connected without any design restrictions on the outer peripheries of the structures 110.

<Modification>

Note that the present invention is not limited to the aforementioned embodiments, and also includes various modifications, alterations and the like as long as the object of the present invention is achieved.

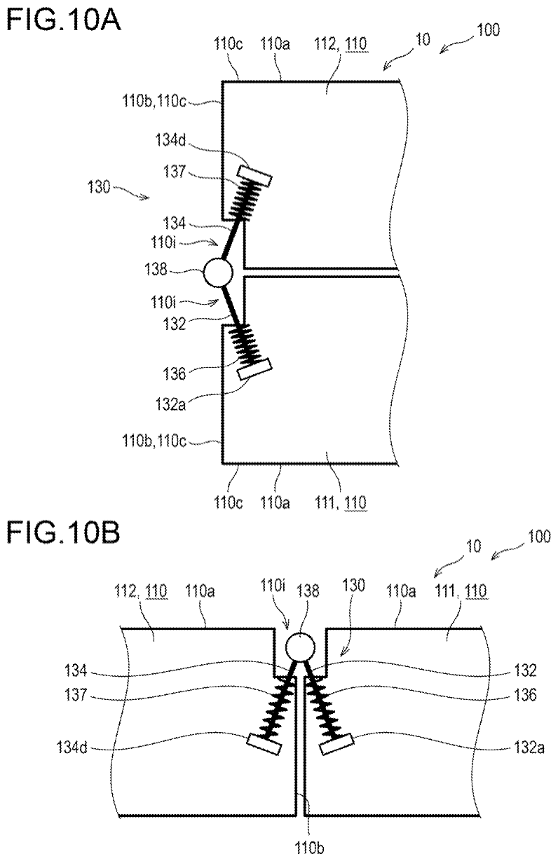

The present invention is not limited to the biaxial hinge structures shown in the first embodiment, the second embodiment, and the third embodiment, but may be a deployable structure 100 of a uniaxial hinge structure in which only a first member 132 and a second member 134 are rotatable as shown in FIGS. 10A and 10B. FIG. 10A is a schematic view in a folded state of the deployable structure 100 according to a modification, and FIG. 10B is a schematic view in a deployed state of the deployable structure 100 according to the modification.

The deployable structure 100 of the present embodiment has a first structure 111, a second structure 112, and a hinge unit 130, and the hinge unit 130 connects the first structure 111 and the second structure 112 rotatably and causes them to transition from the folded state to the deployed state.

In the deployed state, the first structure 111 and the second structure 112 are disposed side by side with each other with end edge portions 110c facing each other. The hinge unit 130 has the first member 132, the second member 134, a first urging member 136 and a second urging member 137, and the first member 132 and the second member 134 are rotatably connected to each other via a rotation shaft 138. The first member 132 and the second member 134 respectively have a first support portion 132a and a second support portion 134d. The first member 132 and the second member 134 are each connected to the end edge portion 110c of the first structure or the second structure 112 slidably in a predetermined sliding direction. A sliding direction of the first member 132 is an extending direction of the first member 132, and a sliding direction of the second member 134 is an extending direction of the second member 134.

A first urging member 136 and a second urging member 137 are disposed respectively between the first support portion 132a and the first structure 111, and between the second support portion 134d and the second structure 112.

In the present embodiment, recessed portions 110i are provided on a rotation shaft 138 side of the end edge portions 110c of the first structure 111 and the second structure 112. The first member 132 and the second member 134 are not each inserted through a side end surface 110b in the first structure 111 or the second structure 112 but are inserted through a surface parallel with the main surface 110a among surfaces of the recessed portion 110i.

The first structure 111 and the second structure 112 rotate around the rotation shaft 138, and thereby the deployable structure 100 deploys. In FIG. 10A, the second structure 112 rotates counterclockwise around the rotation shaft 138 with respect to the first structure 111, and thereby the deployable structure 100 deploys.

In the folded state shown in FIG. 10A, the first urging member 136 and the second urging member 137 urge the first support portion 132a and the first structure 111, and the second support portion 134d and the second structure 112 outward, respectively.

When the deployable structure 100 transitions from the folded state to the deployed state as shown in FIG. 10B, the first urging member 136 and the second urging member 137 urge and move the first structure 111 and the second structure 112 in the sliding direction toward each other. That is to say, the first structure 111 and the second structure 112 respectively slide to a rotation shaft 138 side along the first member 132 and the second member 134. The first structure 111 accommodates the first member 132 inside of the first structure 111, and the second structure 112 accommodates the second member 134 inside of the second structure 112 while the first structure 111 and the second structure 112 are sliding to the rotation shaft 138 side. Thereby, the first structure 111 and the second structure 112 move closer to each other, and a gap between the first structure 111 and the second structure 112 becomes small.

The rotation shaft 138 is accommodated inside of the recessed portions 110i that are provided in the end edge portions 110c of the first structure 111 and the second structure 112. Thereby, it is possible to restrain the rotation shaft 138 from protruding to outside from the main surface 110a of the structure 110.

Various components of the deployable structure 100 or the hinge structure 10 of the present invention do not have to be individually independent. It is permissible that a plurality of components are formed as one member, one component is formed of a plurality of members, a certain component is part of another component, part of a certain component overlaps part of another component, and the like.

The above-described embodiments include the following technical ideas.

(1) A deployable structure comprising a first structure, a second structure, and a hinge unit that connects the first structure and the second structure rotatably to cause the first structure and the second structure to transition from a folded state to a deployed state, the first structure and the second structure being disposed side by side with each other with end edge portions facing each other in the deployed state, wherein the hinge unit comprises a first member and a second member rotatably connected to each other via a rotation shaft, and an urging member, the first member includes a support portion and is connected to the end edge portion of the first structure slidably in a predetermined sliding direction, and the second member is connected to the end edge portion of the second structure, and the urging member is disposed between the support portion and the first structure, the urging member urges and moves the first structure in the sliding direction toward the second structure when transitioning from the folded state to the deployed state, and at least a part of the hinge unit sinks into an inside from an outside of the first structure.

(2) The deployable structure according to (1), wherein the first structure and the second structure respectively form plate shapes including main surfaces and side end surfaces, in the deployed state, the first structure and the second structure are disposed side by side with each other with facing side end surfaces that are the side end surfaces located at the end edge portions, facing each other, and the first member is connected to the facing side end surface of the first structure, and the second member is connected to the facing side end surface of the second structure.

(3) The deployable structure according to (2), wherein in the folded state, the rotation shaft protrudes to an outside from the facing side end surface of the first structure, and in the deployed state, the rotation shaft sinks into an inside of the first structure from the facing side end surface of the first structure.

(4) The deployable structure according to (3), wherein the first structure includes an accommodation recessed portion that accommodates the first member slidably in a predetermined sliding direction, in the folded state, the second member is disposed to cross the sliding direction, and when transitioning from the folded state to the deployed state, the second member rotates around the rotation shaft with respect to the first member, the second member and the first member line up on a straight line, and at least a part of the second member and the rotation shaft are accommodated in an inside of the accommodation recessed portion.

(5) The deployable structure according to (4), wherein the first structure includes a sliding surface smoothly continuing to the accommodation recessed portion, and the second member transitions from the folded state to the deployed state while sliding in contact with the sliding surface.

(6) The deployable structure according to (5), further comprising an assistance urging member that applies an urging force to the deployable structure so that the first member and the second member transition from the folded state to the deployed state.

(7) The deployable structure according to any one of (1) to (6), wherein the second member comprises a second rotation shaft, and a link member and a shaft member that are rotatably connected to each other via the second rotation shaft, the link member is one or a plurality of members each having the rotation shaft and the second rotation shaft as both ends, the shaft member includes a second support portion and is slidably connected to the second structure, and a second urging member is disposed between the second support portion and the second structure, the second urging member urges and moves the second structure toward the first structure when transitioning from the folded state to the deployed state, and a part of the hinge unit sinks into an inside from an outside of the second structure.

(8) The deployable structure according to (7), comprising a plurality of the first structures and a plurality of the hinge units, wherein the plurality of the first structures and the second structure respectively form plate shapes including main surfaces and side end surfaces, in the deployed state, the plurality of the first structures and the second structure are disposed side by side with one another with the side end surfaces of the plurality of first structures respectively facing the different side end surfaces of the second structure, the side end surfaces of the plurality of the first structures, and the side end surfaces of the second structure are respectively connected by the hinge units, when transitioning from the folded state to the deployed state, the plurality of the first structures and the second structure are urged and move toward one another by the urging members and the second urging members, and at least parts in the plurality of the hinge units sink into insides from outsides of the plurality of first structures.

(9) A hinge structure comprising a first bracket, a second bracket, and a hinge unit that connects the first bracket and the second bracket rotatably to cause the first bracket and the second bracket to transition from a folded state to a deployed state, the hinge unit comprises a first member and a second member that are rotatably connected to each other via a rotation shaft, and an urging member, the first member includes a support portion and is connected to the first bracket slidably in a predetermined sliding direction, and the second member is connected to the second bracket, and the urging member is disposed between the support portion and the first bracket, the urging member urges and moves the first bracket in the sliding direction toward the second bracket when transitioning from the folded state to the deployed state, and at least a part of the hinge unit sinks into an inside from an outside of the first bracket.

(10) The deployable structure of (2) or citing (2), wherein the main surface of the first structure and a main surface of a first panel in which the first structure is embedded are along each other, and the main surface of the second structure and a main surface of a second panel in which the second structure is embedded are along each other.

(11) The deployable structure of (2) or citing (2), wherein in the deployed state, a part of the link member sinks into an inside of the first structure from the facing side end surface of the first structure, and another part of the link member sinks into an inside of the second structure from the facing side end surface of the second structure.

(12) The deployable structure of (4) or citing (4), wherein the first member slides in the sliding direction, while the first member is in contact with the first structure in two spots separated in a longitudinal direction of the first member, and a part of the first member sandwiched between the two spots is separate from the first structure.

(13) The deployable structure of (4) or citing (4), wherein a dimension in a thickness direction of a part accommodated in the accommodation recessed portion in the second member (the link member), and a dimension in a thickness direction of the accommodation recessed portion are substantially same, and the deployable structure deploys while the part in the second member sinking into the accommodation recessed portion.

(14) The deployable structure of (5) or citing (5), wherein a retraction space partially defined in the sliding surface is continuously connected to an opening portion of the accommodation recessed portion, and the deployable structure deploys while a part (the link member) of the second member is brought into the accommodation recessed portion through the retraction space.

(15) The deployable structure of (5) or citing (5), wherein in the folded state, the first structure pushes the second member in a part on an opening side of the accommodation recessed portion, in the sliding surface.

(16) The deployable structure of (6) or citing (6), wherein a rotational force that is to rotate around the rotation shaft with respect to the first member and is applied to the second member by the urging member is larger than the rotational force that is applied by the assistance urging member.

What is claimed is:

1. A deployable structure comprising a first structure, a second structure, and a hinge unit that connects the first structure and the second structure rotatably to cause the first structure and the second structure to transition from a folded state to a deployed state, the first structure and the second structure being disposed side by side with each other with end edge portions facing each other in the deployed state,
wherein the hinge unit comprises a first member and a second member rotatably connected to each other via a rotation shaft, and an urging member,
the first member includes a support portion and is connected to the end edge portion of the first structure slidably in a predetermined sliding direction, and the second member is connected to the end edge portion of the second structure, and
the urging member is disposed between the support portion and the first structure, the urging member urges and moves the first structure in the sliding direction toward the second structure when transitioning from the folded state to the deployed state, and at least a part of the hinge unit sinks into an inside from an outside of the first structure.

2. The deployable structure according to claim 1,
wherein the first structure and the second structure respectively form plate shapes including main surfaces and side end surfaces,
in the deployed state, the first structure and the second structure are disposed side by side with each other with facing side end surfaces that are the side end surfaces located at the end edge portions, facing each other, and
the first member is connected to the facing side end surface of the first structure, and the second member is connected to the facing side end surface of the second structure.

3. The deployable structure according to claim 2, wherein in the folded state, the rotation shaft protrudes to an outside from the facing side end surface of the first structure, and in the deployed state, the rotation shaft sinks into an inside of the first structure from the facing side end surface of the first structure.

4. The deployable structure according to claim 3,
wherein the first structure includes an accommodation recessed portion that accommodates the first member slidably in a predetermined sliding direction,
in the folded state, the second member is disposed to cross the sliding direction, and
when transitioning from the folded state to the deployed state, the second member rotates around the rotation shaft with respect to the first member, the second member and the first member line up on a straight line, and at least a part of the second member and the rotation shaft are accommodated in an inside of the accommodation recessed portion.

5. The deployable structure according to claim 4,
wherein the first structure includes a sliding surface smoothly continuing to the accommodation recessed portion, and
the second member transitions from the folded state to the deployed state while sliding in contact with the sliding surface.

6. The deployable structure according to claim 5, further comprising an assistance urging member that applies an urging force to the deployable structure so that the first member and the second member transition from the folded state to the deployed state.

7. The deployable structure according to claim 1,
wherein the second member comprises a second rotation shaft, and a link member and a shaft member that are rotatably connected to each other via the second rotation shaft,
the link member is one or a plurality of members each having the rotation shaft and the second rotation shaft as both ends,
the shaft member includes a second support portion and is slidably connected to the second structure, and
a second urging member is disposed between the second support portion and the second structure, the second urging member urges and moves the second structure toward the first structure when transitioning from the folded state to the deployed state, and a part of the hinge unit sinks into an inside from an outside of the second structure.

8. The deployable structure according to claim 7, comprising
a plurality of the first structures and a plurality of the hinge units,
wherein the plurality of the first structures and the second structure respectively form plate shapes including main surfaces and side end surfaces,
in the deployed state, the plurality of the first structures and the second structure are disposed side by side with one another with the side end surfaces of the plurality of first structures respectively facing the different side end surfaces of the second structure,
the side end surfaces of the plurality of the first structures, and the side end surfaces of the second structure are respectively connected by the hinge units,
when transitioning from the folded state to the deployed state, the plurality of the first structures and the second structure are urged and move toward one another by the urging members and the second urging members, and at least parts in the plurality of the hinge units sink into insides from outsides of the plurality of first structures.

9. A hinge structure comprising a first bracket, a second bracket, and a hinge unit that connects the first bracket and the second bracket rotatably to cause the first bracket and the second bracket to transition from a folded state to a deployed state,
the hinge unit comprises a first member and a second member that are rotatably connected to each other via a rotation shaft, and an urging member,
the first member includes a support portion, and is connected to the first bracket slidably in a predetermined sliding direction, and the second member is connected to the second bracket, and
the urging member is disposed between the support portion and the first bracket, the urging member urges and moves the first bracket in the sliding direction toward the second bracket when transitioning from the folded state to the deployed state, and at least a part of the hinge unit sinks into an inside from an outside of the first bracket.
